(19) United States
(12) Patent Application Publication
(10) Pub. No.: US 2026/0127505 A1
(43) Pub. Date: May 7, 2026

(54) COORDINATING COMPLEX INTERACTIONS OVER COMPUTER NETWORKS USING MACHINE LEARNING

(71) Applicant: Touch Risk GmbH, Zug (CH)

(72) Inventors: Veysel Sinan Geylani, Zug (CH); Mirela Dimofte, Zug (CH); Umut Sevin, Zug (CH); Elif Beyza Peker, Zug (CH); Abdullah Avcu, Zug (CH); Betül Salt Çelik, Zug (CH); Rasha Salim, Zug (CH); Vinayakk Garg, Zug (CH); Kevin Medri, Zug (CH)

(21) Appl. No.: 19/380,630

(22) Filed: Nov. 5, 2025

(30) Foreign Application Priority Data
Nov. 5, 2024 (IN) 202411084617

(51) Int. Cl. G06N 20/20; G06F 9/50

(52) U.S. Cl. CPC G06N 20/20; G06F 9/5022

(57) ABSTRACT

Methods, systems, and apparatus, including computer-readable media, for coordinating complex interactions over computer networks using machine learning. In some implementations, a system receives a request from a remote system over a communication network. The request identifies a particular entity and indicates characteristics of a requested or proposed interaction. The system accesses a profile for the particular entity, where the profile comprises profile data that indicates patterns or characteristics determined from records of previous interactions. The system generates an output from each of multiple machine learning models that have each been trained to predict a likelihood of an outcome. The system generates a prediction for the outcome based on the outputs of the machine learning models. Based on the prediction the system selectively reserves a resource or service from one or more service provider systems over the communication network.

### CROSS-REFERENCE TO RELATED APPLICATIONS

This application claims the benefit of priority under Section 119(a) to Indian provisional patent application Ser. No. 202411084617, filed in India on Nov. 5, 2024, which is incorporated by reference herein.

### BACKGROUND

The present specification relates to coordinating interactions over computer networks, including using machine learning to facilitate interactions among multiple systems over the Internet.

### SUMMARY

In some implementations, a computer system is configured to use machine learning to evaluate and manage the allocation of resources among client devices, servers, and other systems that interact over computer networks such as the Internet.

For example, an artificial intelligence or machine learning (AI/ML) platform can be configured to gather monitoring data indicating the interactions of many systems over time. With the monitoring data, the AI/ML platform trains multiple machine learning models based on the examples of interactions, so that the models learn the patterns of activity of various types of systems and in various different contexts. The AI/ML platform can also create profiles for individual systems or entities and update the profiles over time to track the status and performance capability of these systems or entities. Using the machine learning models and the profiles, the AI/ML platform can then predict the likelihoods of various outcomes as specific interactions or transactions occur. The AI/ML platform can then selectively establish connections or selectively reserve resources based on the predicted likelihoods, on an interaction-by-interaction or transaction-by-transaction basis.

As an example, if a prediction made using the machine learning models indicates that a requested interaction is likely to be performed successfully (e.g., with certain performance criteria satisfied), the AI/ML platform can interact with one or more service providers to allocate resources or provide services to complete the requested interaction. On the other hand, if a prediction indicates that the interaction is not likely be performed successfully, and thus that resources or services provided would be ineffective or wasted, the AI/ML platform can decline to have resources or services reserved or allocated for the interaction. As a result, the AI/ML platform can facilitate and accelerate interactions that are predicted to succeed, as well as block or prevent resources from being expended unnecessarily for an interaction that is unlikely to succeed.

Even if the AI/ML platform declines to allocate resources or services for a requested interaction, the system initiating the interaction receives fast feedback that resources or services are unavailable, which allows the system to quickly source resources through an alternative channel. Client systems that request resources and service providers benefit from quick feedback that is often provided in real time or near real time. Service providers can use the AI/ML platform to more accurately allocate limited resources or finite capacity to interactions with predicted favorable outcomes, and by avoiding providing services that would result in inefficiency, waste, errors, or other poor outcomes.

In many cases, when a user or client device initiates an interaction over the Internet, a single request may result in many different systems contributing or cooperating to fulfill the request. For example, for a given request, multiple different servers, databases, networks, and other elements in the network may each participate in fulfilling the request. The interactions that may be needed are varied and complex, and some interactions may be conditioned on or be dependent on other interactions being performed. As an additional complication, many entities and systems that interact over the Internet are not trusted, and the performance characteristics (e.g., timing, accuracy, reliability, etc.) can vary significantly.

The AI/ML platform can use its predictions to improve interactions among systems over computer networks, especially where resources or services from multiple different service providers are needed. In many cases, there are dependencies where one system or entity does not or cannot provide a resource or service unless or until another system or entity provides a different resource or service. The AI/ML platform can use its machine learning predictions to manage the uncertainty inherent in multi-system interactions, giving increased confidence to service providers that particular interactions or transactions can be completed successfully. In other words, out of a set of requests or possible interactions, the AI/ML platform can use its predictions to identify the requests or interactions most likely to succeed, allowing service providers to allocate limited capacity for those requests. In many cases, this confidence and selectivity enables service providers to more readily provide the resources and services that further service providers depend on, thus mitigating the challenges of dependencies in complex interactions. The AI/ML platform can also coordinate among multiple service providers to obtain the reservations or scheduling of many different resources or services that are needed. When different services providers have different policies or rules (e.g., different thresholds, different timing requirements, different criteria for successful interactions), the AI/ML platform can store and apply the policies and rules of each service provider to collect or build the combination of resources and services needed to fulfill a request.

The AI/ML platform any use any of several different techniques to provide high efficiency and to solve problems with previous machine learning systems. For example, providing the AI/ML platform to perform the analysis for multiple service providers can be much more efficient than requiring each service provider to separately host, train, and run their own models separately. The AI/ML platform allows many different service providers to benefit from the efficiencies and improved outcomes from machine learning predictions, while offloading the monitoring processes, model training, and machine learning inference processing from the service provider systems. The AI/ML platform can be an efficient centralized service available to many service providers to enable the service provider systems to conserve or better allocate limited resources. A separate AI/ML service can operate with much less overhead than if the service providers themselves had to each perform duplicative monitoring, model training, and inference processing.

In addition, using the AI/ML platform to predict outcomes can relieve other systems from having to handle requests. For example, a requested interaction may require resources or services from multiple different service providers to complete. The AI/ML platform can generate a prediction about an outcome of the interaction overall, if each the needed services were provided, and may determine that the performance characteristics (e.g., timing, likelihood of successful completion, etc.) would most likely not meet the criteria set by the service providers if the interaction is attempted. With this prediction, and by applying the stored policies of the service providers, the AI/ML platform can decline the interaction without having to query each of the service providers, thus limiting network traffic and processing load on the service providers'systems. The AI/ML platform can be configured to issue or forward requests to service providers only when the machine learning predictions indicate the thresholds for an efficient or successful interaction are met, and so the service provider systems avoid processing requests that would be denied or would be ineffective or wasteful if granted.

As another example, the coordination the AI/ML platform provides also increases efficiency and decreases load on service provider systems. For example, an interaction or transaction requested by a client device may require resources or services from multiple different service providers, where providing one service from one service provider is dependent on or is conditional based on the availability of another service provider. The AI/ML platform can take the dependency into account when coordinating the commitment of resources and scheduling of services. Identifying when a needed resource or service is unavailable early in a chain of interactions can relieve other systems from having to handle requests. The machine learning predictions may indicate that the interaction overall would meet the criteria of the service providers (e.g., there is a sufficient likelihood of acceptable performance). Then, the AI/ML platform can communicate with the service provider that supplies the dependency (e.g., the resource or service on which other service providers'actions depend). Once the needed resource or service is requested and is confirmed to be available or approved, the AI/ML platform can communicate with other service providers to secure the remaining resources or services that are needed, and can provide confirmation that the dependency is met. On the other hand, if a service provider indicates that a needed resource or service is not available or is not approved, the AI/ML platform can quickly notify a client device or other system that the interaction is cancelled, and network traffic to secure other resources or services for the interaction is avoided.

In some implementations, to minimize latency and maximize the speed of processing, the policies or rules of service providers can provide the AI/ML platform with advance authorization for allocating resources or services under some contexts or conditions. For example, a policy can indicate threshold probability levels or classifications of the machine learning predictions that, if present, would justify allocation of a resource or service. With these policies and authorizations, the AI/ML platform can determine when each of multiple needed resources or services are available for an interaction or transaction, without the need to request a determination from each service provider for each interaction. Then, after determining that the criteria for providing the resources or services are satisfied, the AI/ML platform can send requests in parallel to multiple service providers. In this case, the requests are made to update records and collect interaction details (e.g., session identifiers, transaction identifiers, etc.), without the need to wait for or obtain approval to allocate resources, so these requests can be made and processed in parallel among the different service providers can be used.

The AI/ML platform also improves efficiency and accuracy by making is machine learning models adaptable and applicable to many different situations. The AI/ML platform may be requested to assess a wide variety of different interactions or transactions, involving a diverse group of entities and in any of various different contexts. To provide versatility to accurately assess many different situations, the AI/ML platform can use multiple machine learning models, which can have differences in, for example, model architecture, model size, training state (e.g., model parameter values), training algorithms used, training data used, input data used, and other characteristics. The various models may have differing accuracy for different situations or contexts, so the AI/ML platform can determine the situations or contexts in which each model performs most accurately.

When it is time to make a prediction for an interaction, the AI/ML platform can select a subset of the models to use, based on the historical accuracy of the different models in different situations. For example, if there are 30 trained models, the AI/ML platform can select the top 5 models that have demonstrated the highest accuracy in making predictions in similar contexts (e.g., similar types of entities, similar types of resources and services, similar transaction characteristics, etc.). The AI/ML platform can then use the selected subset of models to make predictions for the current interaction. This can provide high accuracy by using the models that are best for the situation. It can also provide high efficiency by limiting computational demands and power usage, because the AI/ML platform avoids processing with models that are less likely to be accurate for the current situation. In this way, the AI/ML platform can provide a dynamic ensemble of models, where a customized selection from the overall set of models is made for each interaction or for each prediction to be made. The AI/ML platform can select the subsets of models to use based on accuracy measures for the models, such as accuracy scores for each model for each of various different contexts. In some implementations, the AI/ML platform can train a selection model to predict which of the models is likely to be most accurate, where the selection model is trained to based on training data indicating previous contexts and result data indicating whether the predictions of the models were correct.

The use of multiple machine learning models with different characteristics can give the AI/ML platform robustness to make predictions for new contexts and new entities, even without having to create or train new models. Even for new situations, the AI/ML platform can select from its models, for each prediction to be made, from a customized ensemble of models that together provide predictive power for the characteristics relevant to the situation. The prediction of the AI/ML platform can be made by combining the prediction outputs of selected models, such as by generating an average (e.g., mean) probability score, by using different prediction outputs as votes whether an outcome is likely or whether a classification is appropriate, or by determining whether any or at least a minimum number of selected models detect an anomaly.

The AI/ML platform can be configured to update and train its machine learning models and other parameters in an ongoing manner. For example, after predictions are made and the AI/ML platform coordinates resources or services to be provided, the AI/ML platform monitors to detect the outcome of the interaction. If the interaction proceeds as desired, e.g., with the timing, completion, and performance expected or predicted, then this provides additional training data to increase the confidence or reinforce the training for that situation. If the interaction does not occur as predicted, then the AI/ML platform detects the failure and automatically updates the training of the machine learning models to increase accuracy and reduce the likelihood of an inaccurate prediction in the future. This repeated training provides closed-loop feedback that improves the accuracy of the AI/ML platform over time, and also enables the AI/ML platform to adapt as changes occur (e.g., features become more or less predictive of outcomes, patterns of activity shift over time, etc.). Besides training the individual machine learning models, the AI/ML platform can also update or train its module for selecting which subsets of models to use in different situations. This way, the model selection also improves and adapts based on new examples of predictions and later outcomes as more data becomes available.

In some prior systems, machine learning models were able to incorporate information about large trends or repeated patterns effectively, but were not able to retain or use more specific information about particular entities or specific situations.

For example, a model may be trained on examples of many different entities (e.g., individuals, companies, etc.) but the final training state would often omit details about individual entities that, while not important for predictions generally, may be very important for predictions about that entity specifically. In addition, the status, capability, and activity of an entity can change over time, and training a machine learning model may not reflect these changes quickly enough or may require significant processing resources. The AI/ML platform can solve these problems by using profiles for different entities, which can be updated quickly and efficiently for each entity.

The AI/ML platform can create, store, and periodically update a profile for each of various entities identified in records of interactions. Each profile can describe the historical patterns of activity of the corresponding entity, including previous interactions and their outcomes. The profile provides information about the current and historical status and capabilities of an entity, as well as trends or changes over time. The AI/ML platform can generate and update the profiles based on information from a variety of different data sources, including third-party databases and third-party records of transactions. The AI/ML platform can use information from the profiles to generate the set of input (e.g., input feature values) provided to the machine learning models. The profiles and their use in generating input enables the AI/ML platform to be very responsive to changes in status and changes in trends. The profiles improve the accuracy of the machine learning predictions, by providing current information specialized for the entity about which the prediction is made, which the machine learning models can receive as input so the predictions are tailored for that entity's status, activity patterns, and recent trends. The use of profiles allows the AI/ML platform to capture and use new information about specific entities in the machine learning predictions more quickly and with less processing overhead than would be needed to update the training state of the models based on the new information.

The AI/ML platform can also provide accurate predictions by taking into account not just a single entity's status and pattern of activity, but also the status and patterns of activity of other entities that the entity interacts with. The AI/ML platform can use monitoring data from various sources to identify the relationships and patterns of interactions among entities. The AI/ML platform can then use this information to improve predictions by adjusting for the ways that entities may affect each others'behavior. For example, in a supply chain, a retailer may receive items from a distributor, which obtains the items from a manufacturer, which in turn receives components from various different component suppliers. The relationships among these entities, which the AI/ML platform can infer from patterns of interactions over time, can be used to assess the status, reliability, and capabilities of the entities over time.

For example, although the retailer may have a history of high reliability, a recent trend of decreasing reliability of the manufacturer or a component supplier could indicate that for at least some types of transactions, the retailer's reliability could be impacted due to the dependence on the other entities.

In general, the AI/ML platform can use information that it gathers (e.g., profile information, changes in status, acquisition or consumption of resources, etc.) so that machine learning predictions are based on input about an entity as well as information about associated entities (e.g., those that an entity has interacted with or is likely to interact with). To better account for the relationships or reliance among different entities, the AI/ML platform can generate scores that weight or otherwise adjust scores or measures for an entity based on the scores or measures for other entities. The input provided to the machine learning models can include these adjusted scores, or other information about associated entities, so that the machine learning predictions include greater context and more accurate input about an entity when making a prediction. This enables the AI/ML platform to model significant relationships in a larger ecosystem (e.g., a large communication network, a supply chain, etc.) by adjusting the status and capabilities of entities based on the most closely associated other entities that they rely on.

One of the challenges in machine learning systems is the lack of transparency in how machine learning models generate their results. In many systems, each model is considered to be a “black box” during inference processing, and it may be difficult or impossible to determine why the model produced the particular prediction it made for the set of input provided. The present system solves this problem with machine learning models that are configured to indicate the features or factors that most greatly influenced the prediction. For example, a machine learning model can be configured to receive a set of feature values as input, and to produce a prediction output (e.g., a probability score, a classification result, a confidence score, an anomaly detection score, etc.). In addition, the machine learning model can be configured to output importance scores that indicate the relative levels of influence or impact that different inputs had on the prediction output. In some cases, this can include an importance score for each of the features used as input to the model. In other cases, this can include an indication of the most influential features (e.g., the top 10 features, top 5 features, etc.). The ability for models to output importance scores can be trained into the models during model training. In addition, or as an alternative, the AI/ML platform can be configured to generate the importance scores by inspecting the processing within the machine learning models (e.g., node activations, magnitudes of calculation results, intermediate processing results, etc.).

In addition to giving users insight and confidence in the functioning of the machine learning models, the importance scores can be used by the AI/ML platform to improve the accuracy of the machine learning predictions. For example, the AI/ML platform can monitor and track the features or combinations given high importance for various predictions and monitor the actual outcomes that occurred after those predictions. The importance scores can also be saved for each prediction, providing a record of the features that each model relied on for each prediction. This AI/ML platform can use this data set to analyze, for each model, which combinations of features are used when predictions are most accurate and which combinations of features are used when predictions are less accurate. Because different models have different properties, the features that are most predictive or highest-weighted may vary from one model to another. Consequently, the combinations of features that result in high-accuracy predictions can be different for different models, and the AI/ML platform can track and analyze these separately for each model.

In many cases, the AI/ML platform can use the importance scores as an additional check to verify the accuracy or reliability of each model. For example, if a prediction from a model is made based on a combination of features that are historically associated with accurate predictions from that model, the AI/ML platform can have a higher degree of trust or confidence in the prediction. On the other hand, if a model makes a prediction and the importance scores indicate an unusual reliance on some features (e.g., features different from those leading to high-accuracy predictions, or features associated with low-accuracy predictions), the AI/ML platform can assign lower confidence to the prediction. The AI/ML platform can act on the lower confidence by, for example, flagging the prediction as potentially anomalous, discounting or assigning a lower weighting to the prediction lower, or by attempting to corroborate the prediction with other models. In some cases, the AI/ML platform can evaluate the importance scores and flag predictions for administrator review if the importance scores for a model deviate from patterns that have historically accompanied high-accuracy predictions for that model or similar types of models.

In one general aspect, a method performed by one or more computers includes: receiving, by the one or more computers, a request from a remote system over a communication network, where the request identifies a particular entity and indicates characteristics of a requested or proposed interaction involving the particular entity; accessing, by the one or more computers, a profile for the particular entity, where the profile includes profile data that indicates patterns or characteristics of activity of the particular entity that were determined from records of previous interactions of the entity or of other entities; generating, by the one or more computers, an output from each of multiple machine learning models that have each been trained to predict a likelihood of an outcome, where each output indicates a likelihood of the outcome for the requested or proposed interaction, and where each output is generated by the corresponding machine learning model based on input indicating (i) characteristics of the requested or proposed interaction and (ii) information from the profile for the particular entity; generating, by the one or more computers, a prediction for the outcome based on the outputs of the machine learning models; and based on the prediction generated based on the outputs of the machine learning models, selectively reserving, by the one or more computers, a resource or service from one or more service provider systems over the communication network and providing a response to the remote system.

In some implementations, the machine learning models comprise at least one of a neural network, a reinforcement learning model, a support vector machine, a classifier, a regression model, a clustering model, a decision tree, an anomaly detection model, a random forest model, a genetic algorithm, a Bayesian model, or a Gaussian mixture model.

In some implementations, the method includes determining that the prediction satisfies one or more predetermined criteria for providing the resource or service for the requested or proposed interaction. Selectively reserving the resource or service from the one or more service provider systems includes: in response to determining that the prediction satisfies the one or more predetermined criteria, communicating with the one or more service provider systems over the communication network to cause the resource or service to be provided for the requested or proposed interaction.

In some implementations, communicating with the one or more service provider systems includes providing, over the communication network, (i) information from the request indicating the characteristics of the requested or proposed interaction, and (ii) an indication of the prediction or an indication that the prediction satisfies the one or more predetermined criteria.

In some implementations, the method includes determining that the prediction does not satisfy one or more predetermined criteria for providing the resource or service for the requested or proposed interaction; and selectively reserving the resource or service from the one or more service provider systems includes: in response to determining that the prediction does not satisfy the one or more predetermined criteria, (i) not reserving the resource or service for the requested or proposed interaction, and (ii) sending a message to the remote system indicating that the resource or service is not provided for the requested or proposed interaction.

In some implementations, selectively reserving, by the one or more computers, the resource or service from one or more service provider systems includes coordinating with each of multiple service providers such that the multiple service providers respectively provide different resources or services to complete the requested or proposed interaction.

In some implementations, a first resource or service provided by at least one of the multiple service providers is provided conditionally based on availability of a second resource or service from another of the multiple service providers; and coordinating with each of multiple service providers includes obtaining confirmation of availability of the second resource or service to enable the first resource or service to be provided.

In some implementations, selectively reserving, by the one or more computers, the resource or service from one or more service provider systems includes: coordinating with a first service provider system to provide a first type of resource or service and a second service provider system to provide a second type of resource or service, where the second type of resource or service is different from the first type of resource or service, and where providing the second type resource or service of second is conditioned on providing the first type of resource or service, where the coordinating includes: providing, to the first service provider system, prediction data indicating the prediction for the outcome for the proposed or requested interaction or an indication that the prediction satisfies one or more predetermined criteria; after providing the prediction data, receiving, from the first service provider system, a first confirmation message indicating that the first type of resource or service is allocated for the requested or proposed interaction; providing, to the second service provider system, an indication that the first service is allocated for the proposed or requested interaction; and after providing the indication to the second service provider system, receiving, from the second service provider system, a confirmation that the second type of resource service is reserved or allocated for the requested or proposed interaction.

In some implementations, the output from each of the machine learning models includes at least one of a probability score, a classification result, a detected anomaly, or a confidence score.

In some implementations, generating the prediction for the outcome based on the outputs of the machine learning models includes: generating the prediction based on an ensemble of the machine learning models, including determining an amount or proportion of the outputs that indicate that a likelihood of the outcome exceeds a predetermined threshold or represents an anomaly.

In some implementations, generating the prediction for the outcome based on the outputs of the machine learning models includes generating a combined score based on the outputs of the multiple machine learning models.

In some implementations, generating the combined score includes determining a weighted combination in which different outputs have different levels of contribution or influence to the combined score based on previous performance of the machine learning models.

In some implementations, the output from each of the machine learning models includes an importance score for each of multiple different factors, where the importance scores in the output of a machine learning model indicate relative levels of contribution of the corresponding factors to a prediction output of the machine learning model.

In some implementations, each of the machine learning models is configured to receive input indicating a value for each of multiple different features; and generating the output from each of the machine learning models includes generating, for each of the multiple machine learning models, (i) a prediction output indicating a likelihood of the outcome or a likelihood of an anomaly in the outcome and (iii) an importance score for each of the multiple different features, where each importance score indicates a level of influence or impact of the corresponding feature on the prediction output of the machine learning model.

In some implementations, a method includes receiving multiple requests for different types of interactions or for different entities; and using a dynamic ensemble of models to generate predictions for the multiple requests, including, for each of the multiple requests, using a different subset of machine learning models based on one or more of the entity involved, the type of interaction, characteristics of the interaction, or content of a profile of an entity involved in the interaction or one or more associated entities.

In some implementations, the method includes storing a plurality of machine learning models that have each been trained to predict a likelihood of the outcome; and selecting a subset of the machine learning models in the plurality of machine learning models for the requested or proposed interaction; and the generating the output from each of the multiple machine learning models includes generating an output from each of the machine learning models in the subset of the machine learning models.

In some implementations, the method includes determining performance measures indicating accuracy of the outputs of the different machine learning models in the plurality of machine learning models in different contexts; and selecting the subset of the machine learning models includes selecting, from the plurality of machine learning models, a subset of the machine learning models that the performance measures indicate to have the highest performance in a context corresponding to the requested or proposed interaction.

In some implementations, the method includes: accessing a selection model that has been trained to predict or score the relevance of different machine learning models for different contexts; and generating, for each of the machine learning models in the plurality of machine learning models, an output of the selection model indicating a relevance of the machine learning model to a context corresponding to the requested or proposed interaction. Selecting the subset of the machine learning models in the plurality of machine learning models for the requested or proposed interaction includes selecting the subset based on the outputs of the selection model.

In another general aspect, a method performed by one or more computers includes: collecting, by the one or more computers, records of interactions including interactions of multiple different entities that were initiated over a communication network; generating, by the one or more computers, a profile for each of the multiple entities based on the collected records, wherein each profile comprises profile data that indicates patterns or characteristics of activity of the entity and that is derived from interactions of the entity indicated by the collected records; training, by the one or more computers, multiple machine learning models, wherein each of the multiple machine learning models is trained to generate output that predicts a probability of an outcome or to detects whether an anomaly occurs, wherein the output is generated based on input that indicates (i) characteristics of requested or proposed interactions involving entities, and (ii) information indicating characteristics or status of the entities; and using, by the one or more computers, the trained machine learning models to decide whether to reserve or allocate a resource or service that is provided by one or more service provider systems, including deciding whether to reserve or allocate the resource or service to a particular entity for a particular proposed interaction based on output that one or more of the trained machine learning models generated in response to input comprising (i) values indicating characteristics of the particular proposed interaction and (ii) values indicating characteristics or status of the particular entity determined based on information in one or more of the profiles.

Other embodiments of these aspects include corresponding systems, apparatus, and computer programs, each being configured to perform the actions of the methods. Computer programs can be encoded on computer storage devices, e.g., non-transitory computer-readable storage media. A system of one or more computers can be so configured by virtue of software, firmware, hardware, or a combination of them installed on the system that in operation cause the system to perform the actions. One or more computer programs can be so configured by virtue having instructions that, when executed by data processing apparatus, cause the apparatus to perform the actions.

The details of one or more embodiments of the invention are set forth in the accompanying drawings and the description below. Other features and advantages of the invention will become apparent from the description, the drawings, and the claims.

### BRIEF DESCRIPTION OF THE DRAWINGS

FIG. 1 is a diagram that shows an example of a system for using machine learning to facilitate interactions among systems over a computer network.

FIG. 2 is a diagram that shows an example of techniques used for training machine learning models.

FIG. 3 is a diagram that shows an example of using machine learning models to selectively coordinate with service providers to allocate resources or provide services.

FIG. 4 is a diagram that shows another example of using machine learning models to coordinate with service providers to allocate resources or provide services.

FIG. 5 is a diagram that shows an example of a platform that can monitor interactions, characterize system behavior, and train machine learning models.

FIG. 6 is a diagram that shows examples of components of a platform that uses machine learning to facilitate interactions among systems over a computer network.

FIG. 7 is a flow diagram that shows an example of operations for initiating interactions with a new entity.

FIG. 8 is a flow diagram that shows an example of operations to monitor for and update machine learning models based on results following machine learning predictions.

FIG. 9 is a flow diagram that shows an example of operations to detect and mitigate performance issues.

Like reference numbers and designations in the various drawings indicate like elements.

### DETAILED DESCRIPTION

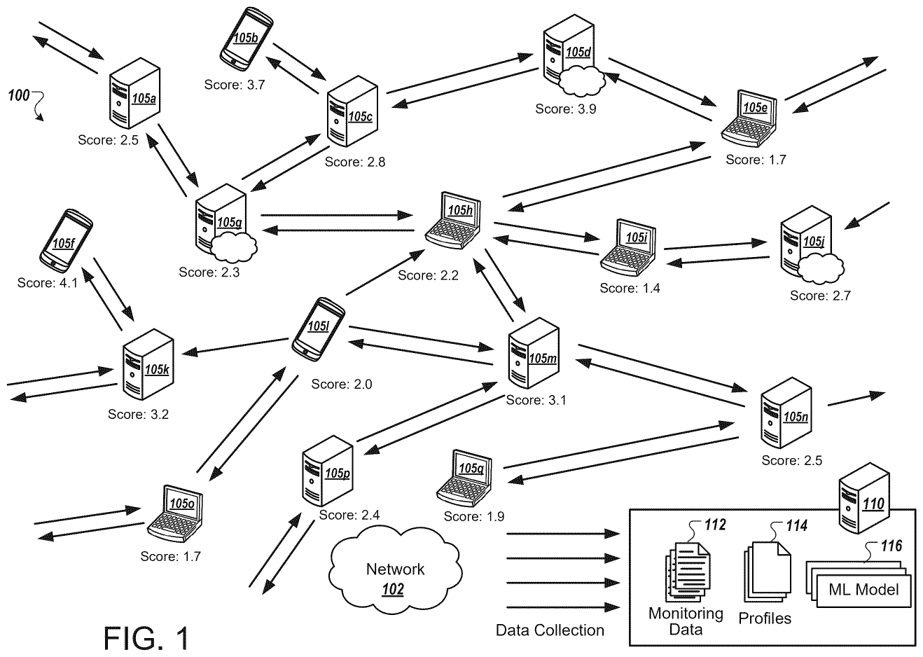

FIG. 1 is a diagram showing an example of a system 100 for coordinating interactions over computer networks. The example shows various different systems 105a-105q (“systems 105”) that interact with each other, indicated by the arrows between the systems 105. These interactions can be initiated or completed at least in part over a network 102, such as the Internet. The systems 105 represent devices or systems of various different entities, such as individuals, companies, service providers, and so on. A computer system 110 provides an AI/ML platform that can facilitate interactions among the various systems 105, including interactions in which service providers provide resources or services to complete other interactions.

The computer system 110 performs data collection to gather monitoring data 112 about the systems 105 and the corresponding entities and the interactions that occur over time. With the monitoring data 112, the computer system 110 generates profiles 114 and machine learning models 116 that enable the computer system 110 to accurately and efficiently predict the status and future behavior of the systems 105 or their associated entities. The profiles 114 can indicate estimates of or inferred measures of the status and pattern of behavior of an entity, according to the previous actions observed in the monitoring data 112. A profile 114 for an entity can be based on the interactions of that particular entity. A profile 114 for an entity may additionally or alternatively be based on interactions of one or more other entities, such as similar entities (e.g., entities that share one or more attributes, such as a same category or classification for one or more of size, type, location, etc. ; entities that are identified with commonalities among activity patterns; etc.). The machine learning models 116 can capture patterns among the entities and their characteristics and the outcomes of attempted interactions, including patterns learned from observing sequences of actions. The computer system 110 can use the monitoring data 112 to characterize the patterns of behavior of different entities and detect when they deviate from those patterns. The computer system 110 can use this information to allocate limited resources, including selectively causing resources or services to be provided depending on predictions of performance or other outcomes.

In the example of FIG. 1, the interactions of the systems 105 may include various types of operations. For example, examples of interactions include requesting or providing a file or another content, requesting or providing a resource, requesting or providing a service, authenticating to a system, applying validation or certification, sending or receiving a message, transmitting or updating records, allocating resources, establishing connections, and so on. In some cases, the interactions can represent communication over the network 102, such as sending messages, loading web pages, making a request through and application programming interface (API), and so on. In some cases, the interactions can represent other actions, such as shipping a package, performing a financial transaction, and so on. Many other types of interactions can be performed, as discussed further below.

Some types of interactions are simple and may simply involve two entities, such as through the direct interaction of one system 105 with another. However, other interactions are more complex and may involve three or more entities. For example, one entity (e.g., user, company, etc.) may make a request or initiate an interaction, where multiple entities or systems are needed for the request to be fulfilled. As an example, a user of the system 105b may interact with the system 105c to request a web page. However, before the web page content is provided, the system 105c may need to interact with another system 105d to verify the user's credentials and authenticate the user (e.g., using a single-sign-on (SSO) system). In addition, the system 105c may need to interact with another system 105g to retrieve content from a database to integrate into the web page. As a result, the request initiated by one entity at one system 105 may involve several other entities, each providing a different resource or service, including entities that may not trust each other.

This need for multiple entities to contribute to an interaction creates a dependency that can slow down or block an interaction from being completed successfully. In addition, some of the resources or services needed may be conditioned on or dependent on other resources being made available (e.g., provided, committed, reserved, etc.), which may require a particular sequence of interaction which can further slow or hinder an interaction from being performed. In addition, when an interaction involves multiple entities, there is a risk that one or more of the parties may fail to provide the service or resources needed, or that the performance may be insufficient (e.g., timing may not meet requirements, requested resources may not be provided, a service may be oversubscribed or a reservation cancelled, etc.).

The computer system 110 can facilitate the efficient allocation of resources by using machine learning models 116 to generate predictions for the outcomes of requested or proposed interactions. For example, if a system 105h issues a request, the computer system 110 can use the machine learning models 116 to predict an outcome of proceeding with the request, such as likelihood of successful completion of a transaction, likelihood that an action will be performed within a particular amount of time, likelihood that resources will be utilized fully or efficiently, and so on. In some cases, the machine learning models 116 predict performance characteristics for the interaction, such as expected measures of reliability, timing, accuracy, throughput, etc. Based on the predictions, the computer system 110 and/or service providers determine, for each requested or proposed interaction, whether predetermined criteria are satisfied for proceeding with the interaction. When the predictions indicate that the criteria or constraints of the service providers are satisfied, then the computer system 110 can coordinate among the service providers to reserve the resources or services needed for the interactions. In many cases, this can involve the computer system 110 receiving a single request from one of the systems 105, coordinating among multiple service providers, and returning response to the request that provides confirmation or access information for multiple resources or services. The computer system 110 can thus provide an interface, such an application programming interface (API), through which systems 105 can request and secure a bundle of multiple types of resources, including from multiple different third-party service providers.

When a request is made that indicates a requested or proposed interaction, the computer system 110 can identify the types of resources or services needed to complete the interaction, as well as potential other related properties (e.g., amount of resources, timing of providing services, etc.). The computer system 110 can identify specific service providers that can provide the needed resources or services, and then request confirmation that the needed resources or services can be committed for the interaction. The computer system 110 can inform the service providers about the prediction results for the interaction (e.g., a predicted outcome, predicted performance characteristics, etc.), to enable the service providers to decide whether to proceed with their portion of the interaction.

In some cases, the computer system 110 can store predetermined criteria that different service providers have set for allocating resources or providing services. The computer system 110 can use these criteria to determine whether all of the various types of resources or services can be provided, with the needed characteristics (e.g., amount, timing, etc.), for the interaction to be completed. If the computer system 110 determines that the resources or services are available, such as by using predetermined criteria or receiving confirmation from the service providers, the computer system 110 can communicate with each of the service providers to reserve the needed resources or services and quickly complete the requested interaction. On the other hand, if the computer system 110 determines that the needed resources or services are not available (e.g., at least one resource or service needed for the interaction is denied or unavailable), the computer system 110 can inform the system 105 that sent the request that the interaction cannot be completed. In this process, the computer system 110 can provide the denial message quickly, to enable the system 105 to try a new request or attempt the interaction through another channel. In addition, the computer system 110 can improve efficiency for service providers as a gatekeeper, generating machine learning predictions and applying the service providers'various policies and rules on their behalf, to prevent resources and services from being expended inefficiently. In fact, by applying the policies and rules, the computer system 110 can decrease the overall load or volume of requests that the service provider systems need to process, because the computer system 110 can identify and filter out interactions that would not meet the service provider's criteria.

The computer system 110 can use several techniques to gather the information needed to make accurate predictions using the machine learning models 116. For example, the computer system 110 can perform data collection to gather monitoring data 112, including records of interactions among the systems 105, such as network traffic logs, transaction logs, status reports, and so on. Many of these data sources can be from third-parties (e.g., service providers, network providers, etc.), rather than from the systems 105 themselves. This is advantageous because it provides the computer system 110 information about a wide set of entities and systems 105, while also relieving the entities of the need to provide extensive information about themselves. For example, rather than requiring an entity or system 105 to respond to an inquiry or directly provide information about the entity or system 105, the computer system 110 can instead build up a description characterizing the entity or system 105 and its status and patterns of activity through other sources.

As an example, the computer system 110 can indirectly determine characteristics and performance history by identifying references to an entity or system 105 in the collected data sets, and can compile the records of interactions to build a profile 114 for the entity or system 105. The computer system 110 can generate and store a profile 114 for each of various entities or systems 105, and can update these profiles 114 as additional monitoring data 112 is received.

The profiles 114 can include scores or measures of various characteristics of entities, which can be indications of their status, activity, patterns, trends, and so on.

The profiles 114 can also indicate the types of interactions that the corresponding entities have performed as well as the other entities that they interact with. For example, the systems 105 as illustrated in FIG. 1 and their corresponding entities can be represented nodes in a graph, with interactions or transactions indicating connections or edges between the nodes. The profile 114 for an entity can indicate the other entities that the entity interacts with, as well as the role (e.g., send to, receive from, provide a resource, consume a resource, etc.) in the interaction. The profile 114 can indicate these connections for one hop (e.g., a direct connection) or more hops (e.g., across one or more intermediate nodes), especially if the amount or magnitude of interactions is significant. The profiles 114 can also indicate the frequency and amount of interactions, the outcomes for interactions, performance measures associated with the entity (e.g., completion rate for interactions, reliability levels, rate of meeting timing requirements, efficiency levels, etc.).

In the example of FIG. 1, each system 105 has a corresponding score indicated, which represents the score for the entity (e.g., individual, company, etc.) associated with that system 105. For clarity in illustration, only one score is indicated for each system 105, with all representing a measure for the same aspect of performance or activity. The profiles 114 can include score or measures for many different aspects of an entity and its activity, including to describe characteristics at different time periods. The illustrated scores indicate the measure of the characteristic for individual entities, as stored in or determined from their respective profiles 114.

However, the computer system 110 can also use the relationships among the entities and their systems 105 to combine information from multiple scores. For example, the status or characteristic of an entity can be significantly affected by the status and characteristics of the other entities with which it interacts. The computer system 110 can capture and use information about these effects by combining the scores or profile information among entities that have interacted in the past.

As an example, for a given action, such as fulfilling an order for a product, there can be many entities involved, including a manufacturer, a distributer, a warehouse operator, a shipping carrier, and so on. As another example, for establishing a network connection there can be internet service provider, cellular network provider, core network provider, and so on. As another example, bank, insurer, payment processor, clearinghouse, etc. In general, an entity may have various suppliers, vendors, service providers, and others whose performance affects the ability of another entity to complete an interaction. The computer system 110 can capture the relationships among systems 105 and entities, including reliance or dependence of one entity on another, in the profiles 114. The computer system 110 can also use that information to generate scores that incorporate this information into scores (e.g., performance characteristic scores for timing, reliability, etc.).

For example, for the system 105h, a score of 2.2 for reliability has been determined from the activity of the system 105h. There are other systems 105 that interact with the system 105h, such as system 105g (score of 2.3), system 105e (score of 1.7), the system 105i (score of 1.4), the system 105m (score of 3.1), and the system 105l (score of 2.0). Other systems that are indirectly connected in the graph can also be considered. The computer system 110 can adjust the score for the system 105h based on the scores of the associated systems 105 that interact with the system 105h. This can include performing a weighted average of the scores, where the score for the system 105 has the highest weight, but scores for other systems 105e, 105g, 105i, 105l, 105m have lower weight. The weighting of the scores for other systems 105 can be based on factors such as the frequency of their interactions with the system 105h, the magnitude of their individual interactions or aggregate magnitude across transactions with the system 105h, the level of reliance or dependence of the system 105h on the other systems 105, the types of interactions with the system 105h, and so on. This weighting or combination of information across entities or systems 105 allows the computer system 110 to more accurately represent the status and capabilities of entities, and thus provide more accurate input to the machine learning models 116 and obtain more accurate predictions. If the performance of one entity changes, it can change the overall performance capability of those that it interacts with. This effect is stronger where an entity's interactions are more concentrated (e.g., focused on a small number of other entities), and less when there is a larger set or more diversity of entities interacted with.

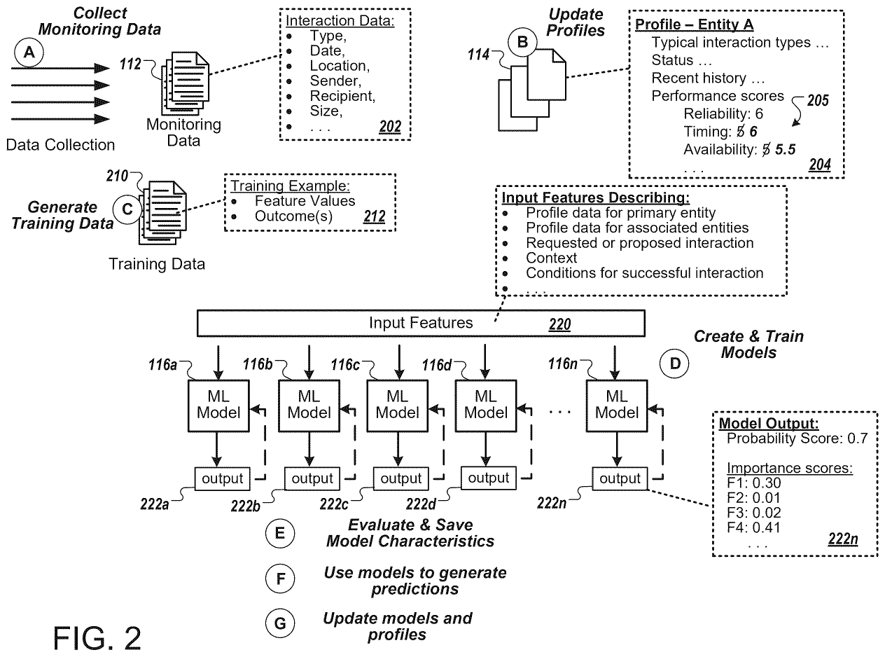

FIG. 2 is a diagram that shows an example of techniques used for training machine learning models. The example of FIG. 2 shows additional elements and functions of the computer system 110, including how the machine learning models 116 are trained. The example includes a series of operations and a flow of data, represented by a series of stages (A) to (G), which can be performed in the order indicated or in another order.

In stage (A), the computer system 110 collects monitoring data 112. The monitoring data can include information about a variety of interactions, including interactions or transactions that occur over the network 102 and interactions or transactions that do not occur over the network 102. For example, an example record 202 of an interaction may indicate a type of interaction, a date or time the interaction occurred (and potentially multiple dates and times for initiation, completion, or other events), a location, an identifier for a sender, an identifier for a recipient, a size, and potentially additional or alternative details about the interaction. The computer system 110 can collect data streams of in an ongoing basis from a variety of third-party sources, such as social media platforms, messaging platforms, governments, corporate reports, credit bureaus, and so on. In some implementations, batches of data are obtained periodically from different sources. The collection of monitoring data 112 can include requesting records, scraping records from Internet sites, contacting third party sources, and in some cases requesting from entities directly. The collected data can include time series data showing actions or outcomes over time, including historical data and longitudinal data.

The monitoring data 112 can include information about interactions that are initiated, as well as the responses or later outcomes, including whether the interaction was completed, timing of competition, and other characteristics. For example, the monitoring data 112 can show when an exchange was requested and if it was completed, if a resource or service was represented to be available and if it was actually provided, and so on. The monitoring data 112 can capture information about any of various outcomes that the computer system 110 will predict.

In stage (B), the computer system generates and updates profiles 116 based on newly received monitoring data 112. The illustrated example shows a profile 204 for an entity titled “Entity A,” which describes aspects of the entity's behavior, including typical interaction types, estimated current status, recent events or actions, and a variety of performance scores. In the example, the recent set of monitoring data 112 shows improvement in two aspects of performance of the entity, such as improving timing and availability, and so the computer system 110 makes an update 205 to the profile 204 to indicate the improved characteristics. Profiles 114 can include may other types of information, including identifying other entities that are interacted with, the nature or type of interactions with those entities, trends or patterns, and so on. Profiles are dynamic, the computer system 110 can continue to adjust them on an ongoing basis as new monitoring data 112 comes in. The profile 114 for each entity can be built up over time, from diverse data sources. In many industries, including finance and insurance, direct underwriting processes are performed which are intensive, costly, and rely on information provided primarily by one party, and after that effort it covers a limited point in time and quickly becomes out of date. The computer system 110, with its profiles 114 build up from diverse data sources over time reduces the burden on entities to supply information, as well as increases accuracy and reliability by combining information from diverse sources and by continually updating over time.

In stage (C), the computer system 110 generates training data 210 for training the machine learning models 116. The training examples can include instances where interactions or transactions were initiated, together with an indication of an outcome. In some cases, the outcome is simple or even binary, e.g., whether an interaction succeeded according to some criteria or not. In other cases, the outcome data can be more detailed, such as providing indications of different aspects or (e.g., amount of time to completion, a rating for the interaction, a level of efficiency achieved, etc.). One example of a training example 212 is shown to include (1) a set of feature values (e.g., values for each of a set of features) and (2) indication of one or more outcomes. In some implementations, the feature values represent the set of input that would be provided to a machine learning model, and the indications of the outcomes can indicate target outputs for the machine learning model to predict. The feature values can include various types of input from the profile 114 of an entity initiating the interaction, such as status data, trend data, previous performance scores, activity levels, an entity type or entity category, and more.

In stage (D), the computer system 110 creates and trains the machine learning models 116 based on the training data 210. The computer system 110 can create many different models 116, represented as models 116a-116n, that have different characteristics. For example, the models 116 can have differences in their model types, model sizes, model architectures, levels of precision, training algorithms used, training data used, and more. For example, the models 116 can include one or more neural networks, reinforcement learning models, anomaly detection models, support vector machines, classifiers, regression models, clustering models, decision trees, random forest models, genetic algorithms, Bayesian models, or Gaussian mixture models. Each of the models 116 can be trained to predict an outcome for proposed interactions or interactions involving entities, including predicting future actions or future behavior of the entities involved in the interactions.

The models 116 can each be configured to make predictions based on input of feature values for a set of feature input features 220, which can describe (1) an entity and its characteristics and pattern of historical actions, and (2) information about a proposed interaction (e.g., type, amount, timing, etc.). The models 116 are each trained to predict the likelihood that the interaction indicated at the input will be completed successfully. In many cases, this involves predicting whether the entity involved in the interaction (e.g., the entity described in or having properties indicated by the input feature values, which may be the entity that initiated or requested the interaction) will perform an action in the future. At least some of the models 116 can each be trained to perform predictions for the same outcome or set of outcomes. Because of the differences in model structure, model type, and so on, the different models 116 will have different properties, and this diversity provides robustness to the predictions that are made.

In the example, each model 116a-116n receives input values for the same set of input features 220, although this is not required to be the case. The input values can include information about the primary entity that initiated the interaction, or on whose behalf the interaction is being performed. As a result, the input values can include information from the profile 114 for that primary entity. In addition, the input values can be based on information about or the profiles 114 of other entities, especially entities that the primary entity has a history or pattern of interacting with or relying on. As discussed above, the scores or status of those other entities can be used to supplement or alter the scores or status of the entity as indicated to the models 116, to reflect the impact of these entities on the status, ability, and tendencies of the primary entity.

Each model 116a-116n produces a corresponding output 222a-222n. As an example, each output 222a-222n can include a prediction output, such as a probability score indicating the probability that a particular outcome will occur for the transaction (e.g., whether the entity initiating the interaction will perform as desired or as represented). Other types of prediction outputs can be used to indicate a likelihood of an outcome, such as an anomaly detection score (e.g., to indicate when the outcome is expected to deviate from a standard or pattern), a classification result (e.g., to classify whether the outcome will occur, or whether one of multiple options is most likely), and so on.

In general, the training of the models 116 can be performed iteratively using many different training examples from the training data 210. For example, training a neural network model can include adjusting the values of weights or other parameters of neural network layers, using backpropagation of error or other techniques to adjust model parameters so that predictions more frequently or more accurately predict the outcomes in the training examples. Other types of models can be trained using statistical calculations, correlation analysis, regression processing, stochastic techniques, reinforcement learning processes, and other techniques.

The models 116a-116n can also be configured to indicate which of the input features 220 most significantly contributed to the prediction output of that model. For example, the models 116a-116n can be configured to provide a set of importance scores that indicate the level of significance or impact of different features on the probability score the model generated for the outcome. In the example, the output 222n is shown to include importance scores for different features F1, F2, F3, F4, and so on.

These feature scores indicate the relative level of influence or contribution of those features to the current prediction (e.g., the probability score of 0.7, indicating a 70% likelihood of a particular outcome). In this example, the importance scores are highest for features F1 and F4, indicating that these two features had the highest impact on, or were relied most by the model 116n on, the generation of the probability score. The models 116 can be trained to produce the importance scores.

In some implementations, the models 116 each produce an importance score for each of the input features 220. In other implementations, the models 116 can be configured to indicate importance in a different way, such as indicating the top N features with the highest impact on the output score. In some implementations, the importance scores may not be outputs of the models 116, but may be scores generated by the computer system 110 by examining the processing within the model 116 for processing a set of input (e.g., by identifying features that have strongest influence for paths or nodes in a decision tree, by identifying magnitudes or activation levels for hidden nodes in a neural network, and so on.) The importance scores provide transparency to understand and track the working of the models 116. This can be very useful for administrators to verify the proper operation of the models 116 and to validate the system overall. Similarly, the indication of the features 220 indicated as most predictive (e.g., most accurate in making a type of prediction) can be used to improve the monitoring, data collection, and model generation that is performed. In addition, the computer system 110 can use the importance scores to detect anomalies and flag predictions for review or correction.

In stage (E), the computer system 110 evaluates the models 116 and saves information about the characteristics of each model 116. For example, the computer system 110 can process sets of feature input values (e.g., feature vectors) and evaluate the accuracy of each model 116 under a range of contexts or situations. Through this analysis, the computer system 110 can determine which models 116 perform best for different interaction types, transaction magnitudes, entity types, and other attributes or combinations of attributes. The computer system 110 can generate and store scores that characterize the accuracy of the different models 116 for each of various different contexts, which the computer system 110 can later use to select the models 116 that are predicted to perform best for the contexts of newly initiated interactions.

In some implementations, the computer system 110 trains an additional machine learning model as a selection model based on the accuracy data for the models 116. The selection model can be trained to indicate, for an input vector with values for the input features 220 for an interaction or for another set of features indicating a context, a measure of predicted accuracy of individual models 116 for that interaction or context. These can be values predicting which model 116 is most accurate, a value for each model 116 indicating whether that model will produce an accurate prediction, a set of values indicating the most relevant or best-suited models, and so on.

In some implementations, the computer system 110 correlates the model accuracy results for predictions with the importance scores for the predictions. With this data, the computer system 110 can identify, for each model 116, the features or combinations of features that are most correlated with accurate predictions or with inaccurate predictions. For example, for the model 116n, the analysis of many different predictions using a testing set of data may reveal that predictions are highly accurate when the model 116n assigns high importance to feature F1, but have low accuracy when the model 116n assigns high importance to feature F2. This information can be used to characterize the model 116n and the situations in which the predictions of that model 116n deserve high confidence or low confidence. When the model 116n is used to make a prediction, the computer system 110 can check the importance scores to determine whether the scores fits a high or low confidence pattern. If the importance scores indicate an unusual combination or a pattern associated with low accuracy, the computer system 110 can flag the prediction for human review, discount the weight of that prediction, or in some cases even disregard the prediction in favor of predictions of other models.

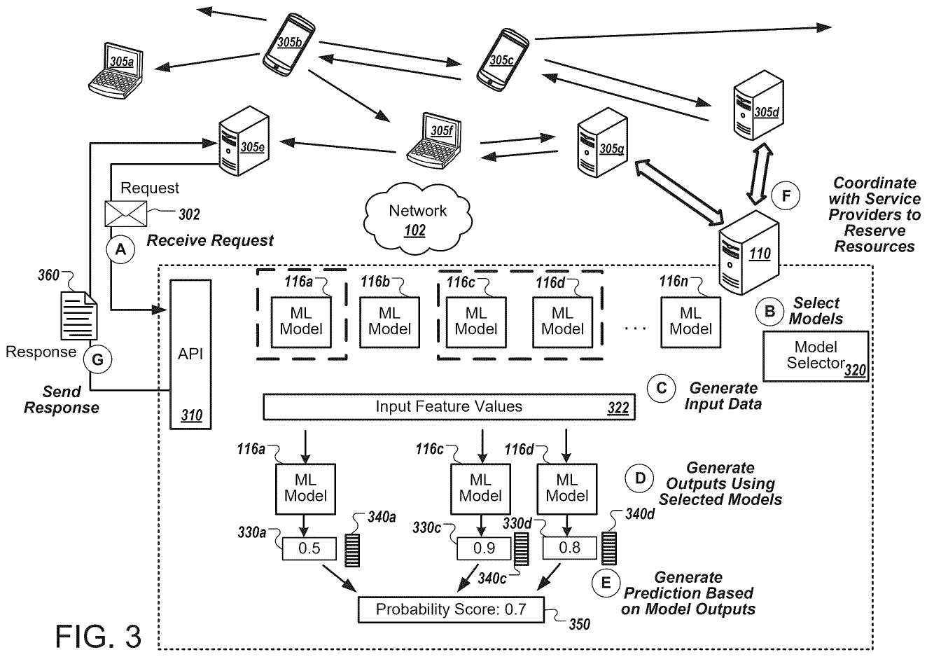

In stage (F), the computer system 110 uses the models 116 to generate predictions, which the computer system 110 can use to selectively advance or block interactions. For example, based on the predictions of the models 116 for a requested or proposed interaction (e.g., a transaction or request from one of the systems 105), the computer system 110 can determine whether the interaction is likely to succeed or be completed according to a set of criteria. If so, the computer system 110 can coordinate the allocation of resources or services from various service providers to cause the interaction to proceed. If the predictions indicate that the interaction is likely to fail, then the computer system 110 can block the interaction from proceeding, to avoid wasting resources. This process is described in further detail with respect to FIG. 3.

In stage (G), the computer system 110 updates the models 116 and the profiles 114. After making predictions and facilitating at least some of the requested or proposed interactions, the computer system 110 continues to collect monitoring data 112 to determine the eventual outcomes of the interactions. The computer system 110 then uses these outcomes to automatically update the models 116 (e.g., to further training with the new examples) as well as to update the profiles 114 for different entities. The updating process can be performed in a repeated or ongoing manner, as new monitoring data 112 is received.

FIG. 3 is a diagram that shows an example of using machine learning models 116 to selectively coordinate with service providers to allocate resources or provide services. The example of FIG. 3 shows how the computer system 110 can use the profiles 114 and machine learning models 116 to make predictions about the outcomes of requested or proposed interactions, and efficiently advance the interactions that meet predetermined criteria (e.g., for efficiency, likelihood of success, ability to meet performance standards, etc.). The example shows a flow of data and a variety of operations, represented as stages (A) through (G), which can be performed in the order indicated or in another order.

In stage (A), the computer system 110 receives a request 302 over the network 102 from a system 305e. The request 302 can be sent through an API 310 that is provided by the computer system 110. The request can 302 can include details about an interaction that is intended, e.g., a requested or proposed interaction that the computer system 110 is requested to facilitate. For example, the request 302 may be a request for the computer system 110 to provide one or more resources or services that are needed to complete the interaction. The interaction may be one that is initiated by the system 305e or a user of the system 305e. As another example, the interaction may be one that is initiated by another party or system, such as by the system 305f or a user of the system 305f. Thus, the computer system 110 can receive requests directly from the user or system that initiates an interaction (e.g., and thus needs resources or services allocated), or the computer system 110 can receive requests from systems that act on behalf of another user or system or that forward a request to the computer system 110.

The request 302 can include a variety of types of information about the interaction or the resources or services needed. For example, the request 302 can include an identifier for the entity or system that initiated the transaction, a type of resource or service needed, a start time and/or end time for providing the resource, an amount or magnitude of a resource or service, and so on. If the interaction is initiated by an entity acting on behalf of another entity, both entities can be identified.

In stage (B), the computer system 110 selects a subset of the models 116 to use in generating a prediction regarding one or more potential outcomes of the interaction indicated in the request 302. The computer system 110 can use a model selection module 320 to evaluate the current context indicated by the information in the request 302 and evaluate the expected level of accuracy of the various models 116 for the context. This can include using identifiers for entities from the request 302 to look up corresponding profiles 114 and using the profile data as part of the context. In some implementations, the model selector module 320 uses records of the accuracy of the models 116 to determine a score for each model 116, where the score indicates a likelihood that the model 116 will provide an accurate prediction for the context, or the score indicates a relevance of the model 116 to the context. In some implementations, a machine learning model has been trained to produce these scores.

The computer system 110 can then select the models 116 that have scores indicating the highest likelihoods of producing an accurate prediction. For example, the computer system 110 can select a predetermined number of the highest-accuracy models 116 for the current context or current interaction being evaluated. This can include ranking the models 116 according to the accuracy scores for the current context, and then selecting a top-ranking portion (e.g., the top 10 models, the top 5 models, etc.). As another example, the computer system 110 can select models 116 according to a threshold level of accuracy or relevance. For example, the computer system 110 may select all models 116 that are each indicated to have a likelihood of 70% or higher in producing an accurate prediction, based on historical accuracy measures or scores from a selection model.

In the illustrated example, out of the full set of models 116a-116n, the computer system 110 selects three models 116a, 116c, 116d as the ones expected to provide the highest accuracy for the interaction indicated in the request 302. This selection allows the selected subset of models 116 that will be used to be the one that best fits the context, e.g., the type of interaction (e.g., transaction), the types of entities involved (e.g., category, size, industry, etc.), the types of resources or services that would be needed, and so on. The selected subset of models 116 serves as an ensemble of machine learning models that is dynamically selected for high accuracy in analyzing the current interaction or context. In addition, selecting a subset of the models 116 (e.g., a proper subset, or fewer than all of the models 116) allows efficient computation by running processing for the most relevant models 116 while avoiding the need to perform processing for the less relevant models 116.

In stage (C), the computer system 110 generates input feature values 322 to provide as input to the selected subset of models, e.g., models 116a, 116c, 116d. The input feature values 322 can be values for some or all of the input features 220 used during training of the models 116. In some implementations, each of the models 116a, 116c, 116d use the same set of input feature values 322 (e.g., receive the same input feature vector). In other implementations, different models 116a, 116c, 116d may be configured to receive and process different sets of feature values (e.g., different input feature vectors, such as different subsets of the input feature values 322).

The computer system 322 generates the input feature values 322 from information in the request 302 as well as information from the profiles 114. For example, some of the input feature values 322 can specify the characteristics and constraints of the interaction to be performed, e.g., start time, end time, type of resources to allocate, amount of resources to allocate, etc. Other input feature values 322 can indicate characteristics of the entity that initiate the interaction, or the entity on whose behalf the interaction is performed. In many cases, this is an entity that also shares responsibility or obligation for the interaction, e.g., to contribute resources or services, such as by providing payment, completing a task, delivering a package, etc.

Scores for the entity, from the entity's profile 114 or derived from the information in the profile 114, can be included in the input feature values 322, such as scores for status, capabilities, reliability, availability, history of meeting timing requirements, and so on. In addition, the input feature values 322 can include information that describes the entity's interaction history (e.g., type, frequency, and characteristics of previous transactions), as well outcomes of those interactions (e.g., timing of completion, whether completion occurred or not, whether the entity met its obligations for performance or payment, etc.).

In addition, the input feature values 322 can include information about other entities that the primary entity interacts with or relies on. As discussed above, scores indicating the characteristics or capabilities of the primary entity involved in the interaction being assessed can be adjusted based on information about the status and history of associated entities (e.g., suppliers, vendors, customers, etc.). This can include entities that are both upstream and downstream in a supply chain. In addition, or as an alternative, information about the associated entries can be provided as separate inputs of the input feature values 322, such as values that identify specific associated entities; indicate a level of concentration, diversity, or reliance on the associated entities; indicate status or performance history of the associated entities; indicate a quality or rating of the associated entities; and so on.

In stage (D), the computer system 110 provides the input feature values 322 to as input to the selected subset of models 116 (e.g., models 116a, 116c, 116d) to generate output from each model 116 in the subset. This can include generating a prediction output 330a, 330c, 330d from each of the models 116 in the subset. In the illustrated example, the prediction outputs are probability scores indicating the likelihood that the some or all of the interaction will be completed successfully. This can include a prediction whether one or more entities involved in the interaction will perform according to some predetermined criteria, given the details about the transaction (e.g., transaction type, timing required, amount and type of resources committed, the particular entities involved, historical data about actions of the entities involved, etc.). The prediction outputs 330a, 330c, 330d may alternatively be other types of outputs, such as a classification result (e.g., indicating a classification for an outcome that is predicted to be most likely to occur) potentially along with a confidence score, an anomaly detection score (e.g., an output indicating whether the input data represents a situation that is considered anomalous compared to previous situations, or with respect to previous situations that resulted in desirable outcomes), and so on.

The models 116a, 116c, 116d in the selected subset also provide sets of importance scores 340a, 340c, 340d that indicate the levels of importance that the models 116a, 116c, 116d placed on the different input feature values 322. For example, the importance scores 340a, 340c, 340d can indicate, for each of multiple input feature values 322 and potentially for each of the input feature values 322, the relative influence or impact of the feature value on the prediction output 330a, 330c, 330d from the model 116a, 116c, 116d. Based on the importance scores 340a, 340c, 340d, the computer system 110 can identify which features had the greatest influence on each model's 116a, 116c, 116d calculations. Different models 116a, 116c, 116d may give different weight or importance to different types of features, which can actually benefit the system by providing robustness and versatility. The computer system 110 can also compare the sets of features indicated as most important with historical patterns for the respective models 116a, 116c, 116d, to determine whether the current reliance on these features is consistent with the patterns indicating high accuracy. If the prediction of a model 116 relies heavily on features that are not demonstrated to be predicted for previous uses or historical data sets, then this can be identified by the computer system 110 as an anomaly that may be mitigated, for example, by triggering human review, by discounting or disregarding the prediction, by adding or substituting in another model 116, and so on.

In stage (E), the computer system 110 uses the prediction outputs 330a, 330c, 330d to determine a prediction for the interaction. For example, the computer system 110 can generate a combined score 350 based on the prediction outputs 330a, 330c, 330d for the respective models 116a, 116c, 116d selected as the subset of models 116 that is best suited for analyzing the current interaction. In some implementations, the combined score 350 is an average of the prediction outputs 330a, 330c, 330d (e.g., arithmetic mean, median, geometric mean, etc.). For example, in this example, the combined score 350 is an probability score that is an arithmetic mean of the probability scores in the prediction outputs 330a, 330c, 330d. In some implementations, the combined score 350 can be a weighed combination of the prediction outputs 330a, 330c, 330d, such as by weighting each prediction output 330a, 330c, 330d by a measure of accuracy or relevance (e.g., overall accuracy of the model 116 that produced the prediction output, accuracy of the model 116 for the particular context or interaction type at issue, relevance or confidence scores used when selecting the subset of models which indicate how appropriate or how likely the model 116 is to be accurate, a measure of similarity or anomaly between (i) the features the model 116 relied on as indicated by the importance scores 340 and (ii) the features that the model 116 relies on when accurate predictions are made, etc.).

In some implementations, the combined score 350 is the result of voting, where the votes are determined from the prediction outputs 330a, 330c, 330d. For example, the votes may set based on the whether the prediction outputs 330a, 330c, 330d indicate greater than a 50% likelihood of the interaction meeting success criteria (e.g., meeting a set of performance standards, one or more entities fulfilling commitments, etc.). A voting rule can be set also, such as the amount or proportion of votes that decides the overall prediction. For example, a prediction of a successful completion of the interaction may require more than half of the votes, and a vote for successful completion requires more than 50% probability. In the example, based on the probability scores, two out of the three models 116a, 116c, 116d vote that successful completion is likely, and so the overall prediction would be that the interaction is likely to succeed.

In stage (F), the computer system 110 coordinates with various service provider systems to reserve resources or services needed for the interaction. In the example, the service providers systems are represented as systems 305d, 305g. The request 302 can be a request for a particular resource or service, which may need involvement by one or more service providers to fulfill. In some cases, even if a single resource or service is requested, a service provider may make providing that resource or service conditional on receiving or confirming the availability of a different resource or service. This can result in dependencies and significant overhead and delay to acquire all of the resources and services that are needed to fulfill the original request 302.

The computer system 110 can improve efficiency significantly by managing the allocation of resources or services, including where the resources or services of multiple service providers are bundled together. This is convenient for the systems making requests, because they can make a single request to the computer system 110 (e.g., through the API 310) and are relieved of the management processing and overhead of identifying service providers and gaining approval or allocation of resources or service from each service provider. The computer system 110 abstracts away the complexity of many multi-step or multi-party interactions, so that users or systems can simply request and receive bundles of resources and services without the need to track, assemble, and coordinate delivery of those resources and services themselves. This makes a much wider set of interactions available, because systems can simply send a request to one service, e.g., the computer system 110, which can orchestrate the allocation and combination of a diverse set of resources and services.

In the example, the computer system 110 analyzes the request 302 and determines that a particular resource or service is needed to proceed with the interaction indicated in the request 302. The computer system 110 identifies a service provider system 305d that is capable of providing the needed resource or service. In some implementations, the computer system 110 is configured to consistently use the same service provider system 305d each time that type of resource or service is requested. In other implementations, the computer system 110 can store a database or set of profiles to describe multiple different service provider systems that are able of providing the same services, and the computer system 110 can select which service provider system to use in support of a given interaction based on various factors, such as load, availability, performance (e.g., history of reliability, levels of capacity, etc.), and so on.

In the example, the computer system 110 determines that a second resource or service is needed. For example, the selected service provider 305d may be able to provide the needed resource or service (e.g., providing a data set, shipping a product, providing a loan, etc.), but may indicate that the resource or service is conditional on obtaining the second resource or service (e.g., network bandwidth from a network infrastructure provider, insurance, third-party identify verification, indemnity, logistics services, etc.) from another service provider. As a result, the computer system 110 identifies another service provider 305g that can provide the second resource or service that will be needed to fulfill the conditions or constraints of the first service provider 305d and complete the interaction (e.g., transaction) indicated by the request 302.

Depending on the situation, there may be additional resources and services from yet additional service providers that may be needed, each with their own conditions or constraints, which the computer system 110 can identify and select service providers to fulfill.

The computer system 110 can use the prediction 350 for the interaction to coordinate the allocation of resources and services of the service providers 305d, 305g. One or more of the service providers 305d, 305g may have a policy or rule that limits the provision of a resource or service unless there is a minimum level of confidence or likelihood that the interaction will achieve a desirable outcome and not waste resources. For example, in a wireless network, it is preferable not to allocate limited resources unless the allocated resources will be utilized and not wasted. As another example, a logistics provider may have limited capacity and so may not be willing to reserve cargo capacity for a shipment unless there is a high likelihood that the shipment will be ready on time for shipping. As another example, a lender may be unwilling to extend credit unless there is a high likelihood of being repaid, or an insurance provider may be unwilling to insure a loan unless there is a high likelihood that the borrower will meet his obligations (e.g., a low likelihood of default).

The computer system 110 can use the prediction 350, made using the results of multiple machine learning models 116a, 116c, 116d, to assess potential interactions (e.g., proposed transactions) and help ensure that resources and services are allocated for only the interactions that meet each service provider's requirements. In some implementations, the computer system 110 can provide its prediction 350 about the outcome(s) of the interaction to the service provider systems 305d, 305g, so the service providers can examine the situation and approve or deny providing the resources or services needed.

To minimize latency and offload processing from the service provider systems 305d, 305g, the computer system 110 can store and apply policies and rules of the service providers, so that the computer system 110 can itself determine whether the characteristics of an interaction and the prediction 350 for its outcome meet the conditions for each of the service providers. The computer system 110 can store information about the capacity and requirements of the service providers, and can have advance approval that certain resources or services will be provided if the conditions in the policy or rules are met. With this information, the computer system 110 can determine for each requested or proposed interaction whether each of multiple resources or services from third-party service providers can be provided, even without having to contact the service provider systems to assess each interaction. In effect, the computer system can filter the requested or proposed interactions to avoid or block proceeding with interactions that the machine learning predictions indicate do not have the probability of success or risk profile that the service provider requires.

If the conditions for providing the needed resources and services are met, based on the prediction 350 for the requested or proposed interaction, then the computer system 110 communicates with the service provider systems 305d, 305g to finalize the reservation of the resources or services. This can involve causing the service provider systems 305d, 305g to approve, allocate, reserve, schedule, commit, provide, or otherwise make the resources or services needed, as well as receiving confirmation that the resources or services are available and/or reserved. This can also include obtaining other information to facilitate tracking and coordination among the service providers and other entities, such as a session identifier, a transaction identifier, a resource address, and so on. As another example, the service provider systems 305d, 305g can provide other information that is used to further interaction, such as encryption keys, passwords or codes, network addresses for accessing the resources or services being provided, and so on.

In stage (G), the computer system 110 provides a response 360 to the system 305e that sent the request 302. When the prediction or the combined score 350 indicates a high likelihood of success, and the criteria of the service providers is satisfied, then the response 360 can include a confirmation that the interaction is approved and proceeding. In this case, the response 360 can include information about the resources or services needed to further the interaction, e.g., a network address for accessing a resource or service, a session identifier or transaction identifier for the interaction, and so on.

If the prediction or the combined score 350 indicates a low likelihood of success, or the criteria of the service providers is not satisfied and so needed resources or services are not available, then the response 360 can indicate that interaction is not approved or is not able to proceed. The computer system 110 can be configured to provide this information quickly, e.g., based on machine learning predictions and stored policies or rules of service providers, often without needing to wait for communication with the service provider systems. By detecting early when an interaction will fail to receive the needed resources and services to proceed, the computer system 110 can enable the requesting system 305e to quickly re-try its request with changed parameters or secure resources or services through other channels.

After an interaction is approved and facilitated by the computer system 110, the computer system 110 continues to track the outcome of the interaction. For example, the computer system 110 can track whether the service provider systems 305d, 305g provide the resources or services they approved, and also whether the system 305e completed the actions it committed to or represented on behalf of another entity. In general, the computer system 110 can track any of various outcomes of the interaction. With the outcome data, the computer system 110 can update the profiles 114 for the entities involved, as well as update the training state of the machine learning models 116, especially for the particular machine learning models 116a, 116c, 116d which were used to generate machine learning predictions for the interaction.

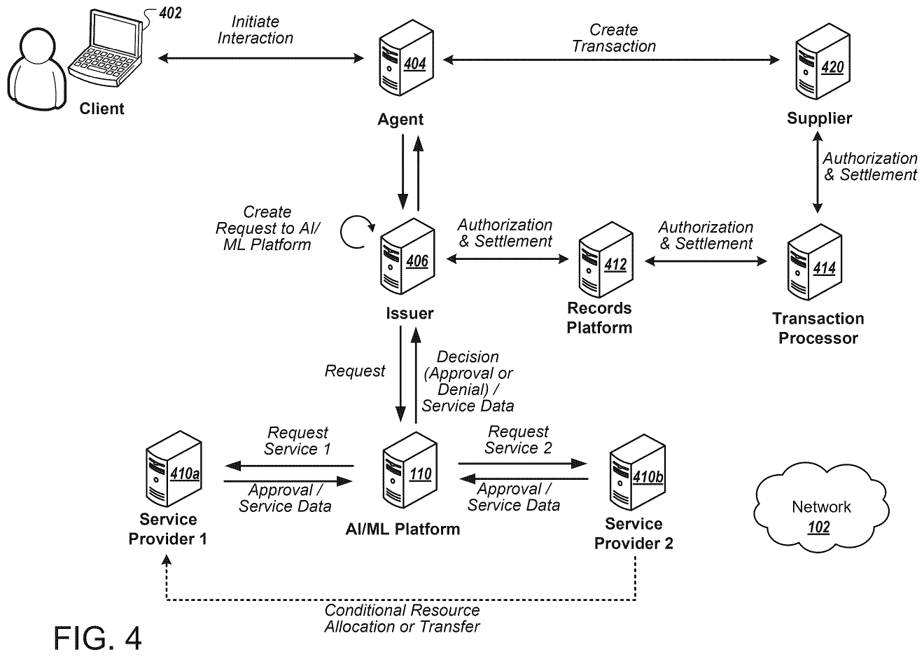

FIG. 4 is a diagram that shows another example of using machine learning models to coordinate with service providers to allocate resources or provide services.

The figure shows an example of ways that the techniques of the AI/ML platform provided by the computer system 110 can be applied. For example, the example shows examples of how some of the processing of FIG. 3, including coordinating the allocation of resources or services among multiple service providers, can be performed. As discussed below, these techniques can be applied to improve digital payment processing and infrastructure in the financial industry. The same techniques can also be used to improve efficiency and responsiveness in many other industries.

The example shows a client system 402 that initiates an interaction with an agent system 404. For example, the client system 402 may send a request for a transaction to be performed, or for a transaction to be created on behalf of a user, company, etc. In some cases, the agent system 404 acts as an intermediary to interact with other systems and build a transaction that meets the needs of the user of the client system 402. This may involve identifying a supplier 420 that can provide what the user of the client system 402 needs, as well as specifying the details of the transaction (e.g., timing, location, cost, items or services involved, etc.).

Even after the transaction characteristics may be determined, there may be additional resources or information that is still missing for the transaction to be completed. For example, the user of the client system 402 and/or the agent system 404 may not be willing or able to immediately provide the funds to complete the transaction. The interaction of several different systems, facilitated by the computer system 110, can provide the infrastructure to complete the transaction. For example, the agent system 404 can send a request to an issuer system 406 to issue needed credentials or digital payment resources. For example, the issuer system 406 can be an entity that issues digital payment cards or virtual card numbers (VCNs), together with a record platform 412. A digital payment card or VCN can be limited-use or special purpose payment mechanism that can be dynamically created and can be during a limited amount of time. The VCN can be generated in a different manner from typical credit cards or debit cards, often with randomly generated numbers, but can be linked to an existing account. A VCN can be linked to a credit card account, but allows for payment processing without exposing the official credit card number for the account. A VCN can be created for an existing account or for a newly created account.

Although the issuer system 406 and records platform 412 are configured to issue digital payment cards or VCNs and process digital transactions, they typically do not provide the accounts or actual credit needed for the transactions. To obtain this, the issuer 106 sends a request to the computer system 110, which includes the information about the entities involved (e.g., the user or company for the client system 402, user or company of the agent system 404, the supplier 420, etc.) and details of the transaction (e.g., type, timing, amount, etc.). The computer system 110 then uses the machine learning models 116 as described with respect to FIG. 3, as well as profiles 114 for the entities indicated in the request, to make a prediction about an outcome for the transaction, e.g., whether funds loaned would be repaid on time.

Based on the prediction, the computer system 110 selectively secures resources and services to facilitate issuance of the VCN and completion of the transaction. For example, the computer system 110 can apply the policies and rules of services providers 410a, 410b to obtain both credit to support the VCN as well as insurance for the credit being supplied. For example, a first service provider 410a can be identified to provide credit or working capital. A second service provider 410b can be identified to provide insurance for the credit provider. The computer system 110 can use the machine learning prediction for the transaction to determine whether the risk or a likelihood of successful outcome justifies proceeding with the transaction. One or both of the service providers 410a, 410b may set their own policies or rules that define criteria for the level of probability or confidence in a successful outcome that is needed to proceed (e.g., less than 10% of default, less than 5% of default, etc.). If the computer system 110 determines that the transaction satisfies these criteria, the computer system 110 requests the services needed (e.g., credit, insurance, etc.) and receives confirmation of the approval of the services and service data (e.g., transaction identifiers) for the services being provided.

With the appropriate resources reserved, the computer system 110 provides the issuer system 406 a decision on the request. For example, when the services needed are approved, then the computer system 110 provides an approval notice and the identifiers and other data to move forward with the creation of the digital payment card or VCN for the transaction. In this case, the issuer system 110 then coordinates with the records platform 412 (e.g., a digital card payment company) to issue a VCN and to perform authorization and settlement for the transaction between the agent system 404 and the supplier system 420. The VCN is linked to an account of the agent with the service provider 410a, which may be a new account or an existing account, for the agent to settle within a defined period of time.

In general, the computer system 110 can be used to provide bundled credit line and insurance services for individual digital payment transactions, where each individual transaction can be assessed and approved using the machine learning models 116.

For example, a separate VCN can be generated for each transaction, so that the amount of credit issued and the corresponding insurance provided are matched and tracked to that VCN. In other implementations, a VCN may be re-used for an entity (e.g., agent) across multiple transactions, but a separate transaction identifier or code may be used to specify and track the bundled credit issuance and insurance issuance for that specific transaction.

If the machine learning predictions indicated that the likelihood of a successful transaction was not sufficiently high (e.g., likelihood of default was too high, an anomaly was detected, etc.), or if the needed services (e.g., credit, insurance, etc.) could not be allocated for another reason, then the computer system 110 notifies the issuer 406 that the resources for the VCN are denied. The issuer 406 then informs the agent system 404 that the VCN option is not available, and that the transaction would need to proceed with a different source of funds.

These techniques can be applied to facilitate transactions for booking travel.

Travel intermediaries (e.g., travel agents) often are required to provide payment immediately when booking flights, hotels, and other travel services on behalf of clients, but often do not receive payment from the clients until later. As a result, travel intermediaries often need access to working capital in amounts that can vary significantly from day to day and which are often needed very quickly (e.g., in order to reserve a flight before it becomes unavailable).

The computer system 110 can enable businesses and individuals to obtain access to access credit lines, where default risk is mitigated through embedded insurance services linked to each digital payment transaction. The computer system 110 can monitor granular transactional data generated by digital platforms from suppliers and customers on an ongoing basis. The computer system 110 can assess receivables and payables transactions to build the profiles 114 and facilitate easy access to bundled credit and insurance services. The computer system 110 utilizes the machine learning models 116 to analyze each individual digital payment transaction to dynamically assess insolvency risk. The use of historical data and data from external data sources increases the accuracy of predictions and enables the computer system 110 to improve and adapt over time. The computer system 110 can integrate transactional data analysis with credit and insurance provisioning for each transaction, which can enhance financial security and operational efficiency for users across various industries.

Businesses and individuals often face challenges accessing credit lines due to the perceived risk of default. Traditional credit assessment methods rely heavily on historical credit scores, which may not accurately reflect the current financial health of the applicant. Furthermore, the process of securing credit lines is often time-consuming and inefficient, often requiring extensive documentation and manual verification. This process is burdensome and slow, and often fails to account for third-party information about the status of the applicant. Traditionally, insurance products that mitigate credit risk have typically been separate from the credit issuance process, leading to fragmented solutions that do not leverage the most recent data or data from diverse sources, and so are not sufficiently accurate. The integration of transactional data analysis with credit and insurance services can provide dynamic, real-time risk assessment and mitigation for each individual transaction. In other words, the computer system 110 can coordinate the provision of credit and insurance together, with approval and tracking being done on a transaction-by-transaction basis.

In some implementations, the computer system 110 provides a bundled credit line and insurance solution for individual digital payment transactions. The computer system 110 can continually monitor transactional data generated by digital platforms, including from suppliers and customers. The computer system 110 can use AI/ML algorithms to analyze each proposed digital payment, based on profiles 114 and machine learning models 116 generated using historical data and external data sources. The computer system 110 can assess insolvency risk based on the analyzed data for each transaction. When the machine learning predictions indicate a sufficiently low level of risk the computer system 110 can coordinate with service providers to provide a credit line to businesses or individuals for each transaction, where default risk is protected by an embedded insurance solution. The computer system 110 can facilitate the issuance of virtual card numbers (VCNs) to manage digital payments. The computer system 110 can also provide real-time risk assessment and credit line adjustment based on transaction data for each transaction.

The computer system 110 can include several components or modules that work together to provide various features of the system, including:
Digital Payment Platform: The core module interfaces with various payment systems to collect and process transactional data in real-time. It supports multiple digital payment methods, including virtual card numbers (VCNs), and integrates seamlessly with existing financial infrastructure.
AI/ML Algorithms: Advanced AI/ML algorithms are used to analyze transactional data, historical financial data, and external data sources. These algorithms assess insolvency risk by identifying patterns and anomalies that indicate potential financial instability for each transaction.
Credit Provisioning Module: Based on the risk assessment provided by the AI/ML algorithms, the credit provisioning module issues credit lines to businesses and individuals for each transaction. This module dynamically adjusts credit limits in real-time, ensuring that the credit provided is aligned with the current financial health of the applicant for each transaction.
Insurance Module: The insurance module embeds insurance solutions within the credit provisioning process for each transaction. It offers coverage for default risk, ensuring that the credit provider is compensated in the event of a default for each individual transaction. This module integrates with leading insurance providers to offer seamless and comprehensive coverage.
Data Monitoring Module: This module continuously collects and analyzes transactional data from suppliers and customers. It ensures that the system has up-to-date information on the financial health of all parties involved, enabling dynamic and accurate risk assessment for each transaction.
User Interface: The user interface facilitates interaction with business clients and customers. It provides a dashboard for monitoring credit lines, insurance coverage, and transactional data, allowing users to manage their financial activities efficiently.

The process of assessing or managing transactions can include several phases or steps:
Transaction Inception: Digital payment transactions are initiated and monitored by the system. The data monitoring module collects transaction details in real-time.
Data Collection: Transactional data, including payment amounts, frequencies, and counterparties, is collected and fed into the AI/ML algorithms for analysis.
Risk Assessment: The AI/ML algorithms analyze the collected data to assess insolvency risk for each transaction. This analysis includes evaluating historical payment behavior, external economic indicators, and other relevant data points.
Credit Line Issuance: Based on the risk assessment, the credit provisioning module issues a credit line to the applicant for each transaction. The amount and terms of the credit line are dynamically adjusted based on the ongoing risk assessment for each transaction.
Insurance Claim: In the event of a default, the insurance module triggers a claim to cover the unpaid amount for each transaction. The insurance provider compensates the credit issuer, mitigating the financial risk associated with the default for each transaction.

One example use case for the computer system is in the travel industry, where intermediaries and hotels often face delayed payments and financial instability. The system monitors receivables and payables, assessing the financial health of travel agents and service providers. By providing credit lines with embedded insurance for each transaction, the system ensures continuous business operations and mitigates the risk of default.

Another example use case is in supply chain management. In industries with complex supply chains, the system can monitor transactional data between suppliers and customers. By assessing the financial health of each party, the system provides credit lines that facilitate smooth transactions while mitigating the risk of insolvency through embedded insurance coverage for each transaction.

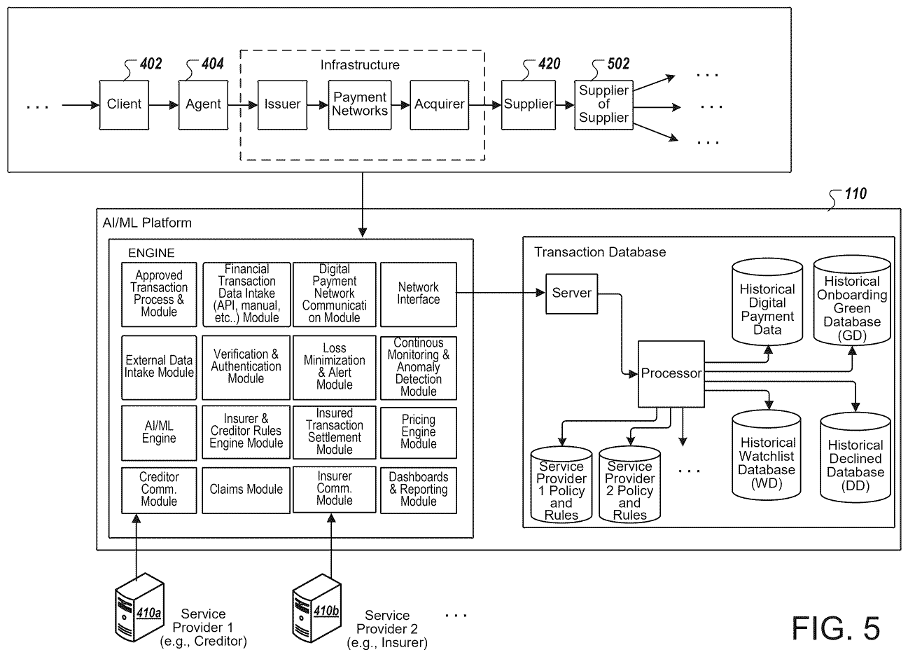

FIG. 5 is a diagram that shows an example of a platform that can monitor interactions, characterize system behavior, and train machine learning models. The figure shows an example ecosystem for the platform, showing various modules and their interactions with different stakeholders. The example of FIG. 5 is shown with examples of two types of service providers 410a, 410b, e.g., a creditor and an insurer, but the same techniques and principles can be applied for other service providers that provide any of various different services, e.g., network connectivity provider, cloud computing provider, data storage provider, authentication or identity verification provider, shipping or logistics provider, warehouse or physical storage provider, and so on.

The example of FIG. 5 shows that the computer system 110 can receive and use data about various different parts of a supply chain, beyond simply the parties directly involved in a transaction. For example, although a transaction to be analyzed is a transaction between the agent 404 and the supplier 420, there can be other digital payment infrastructure involved (e.g., issuer of a VCN, payment networks, an acquirer, etc.), and also there are also upstream entities to consider (e.g., a client 402 of the agent 404) and also one or more suppliers 502 of the supplier 420. By tracking the status, reliability, and other characteristics of many entities, and making machine learning predictions using information about upstream and/or downstream entities in the supply chain, the computer system 110 can provide much more accurate predictions, anomaly detection, and risk management than other systems.

In the case of travel transactions, the client 402 can be an individual or a corporate entity, and can be the party that initiates transactions and payments. The agent 404 can be a travel intermediary that acts as the buyer for travel services and manages transactions with travel suppliers. The issuer issues virtual cards (e.g., VCNs) and manages authorizations. The payment networks acquirer facilitates transaction processing. The supplier 420 provides goods and services to the travel intermediary, often by reliance on other suppliers, such as a supplier 502 of the supplier 420 and others. In the example, the service provider 410a is a creditor that provides credit lines for transactions. The service provider 410b is an insurer that offers and provides insurance to cover transaction risks.

The computer system 110 can include historical databases, which can store a copy of various types of information, for example, a green database (GD) includes historical onboarding data for entities, including travel intermediaries or other entities that obtain credit through a VCN. A declined database (DD) stores historical information about interactions or requests that were declined. A watchlist database (WD) stores a watchlist of previous transactions.

The computer system 110 can include various server modules and core modules, such as:
a financial transaction database processor that processes transaction data;
creditor policy and rules, which specify the criteria, procedures, and requirements set by creditors to control when credit is provided;
insurer policy and rules, which specify the criteria, procedures, and requirements set by insurers to control when insurance is provided;
a financial transaction data intake module, which can handle data intake via an API, manual input, or other channels;
an external data intake module that integrates information received from external data sources;
a verification and authentication module to verify and authenticate data from monitoring or from requests;
a creditor communication module that facilitates communication with creditors; and
an insurer communication module that facilitates communication with insurers.

The computer system 110 can include various processing and decision-making modules, such as:
an approved transaction processing module to process approved transactions;
an insurer and creditor rules engine module, which applies rules of the service providers to determine whether to approve a transaction;
a continual monitoring and anomaly detection module, which monitors incoming transaction data (e.g., requests), along with other monitoring data, and detects anomalies that would indicate that a transaction carries increased risk or does not fit the pattern of other allowable or successful transactions;
a pricing engine module that can determine pricing for transactions;
a digital payment network communication module that interfaces with digital payment networks; and
a dashboard and reporting module which generates reports and data for dashboards to facilitate monitoring.

The computer system 110 can include various components in an AI/ML engine, such as components to create, train, and update the machine learning models 116, as well as select subsets of the models 116 appropriate for a given transaction and run the selected subset of models 116 to determine a prediction for each transaction. The AI/ML engine is often central to processing and decision-making for the computer system 110, and has a primary role in analyzing data to provide insights and determine whether criteria for approval of a transaction (e.g., issuance of resources and services) should be performed.

The computer system 110 can include various other components, such as:
an insured transaction settlement module that handles the settlement of insured transactions;
a claims module that manages claims in the event of defaults;
a loss minimization and alert module that alerts stakeholders to potential losses and helps minimize risks; and
a network interface that ensures seamless communication between different modules and stakeholders.

In general, the computer system 110 integrates multiple modules and stakeholders and can provide seamless, secure, and efficient management of digital transactions. By leveraging AI/ML, continual or ongoing monitoring, and robust communication channels, the platform provides a comprehensive ecosystem that supports, for example, credit provisioning, risk assessment, and insurance embedding for each transaction.

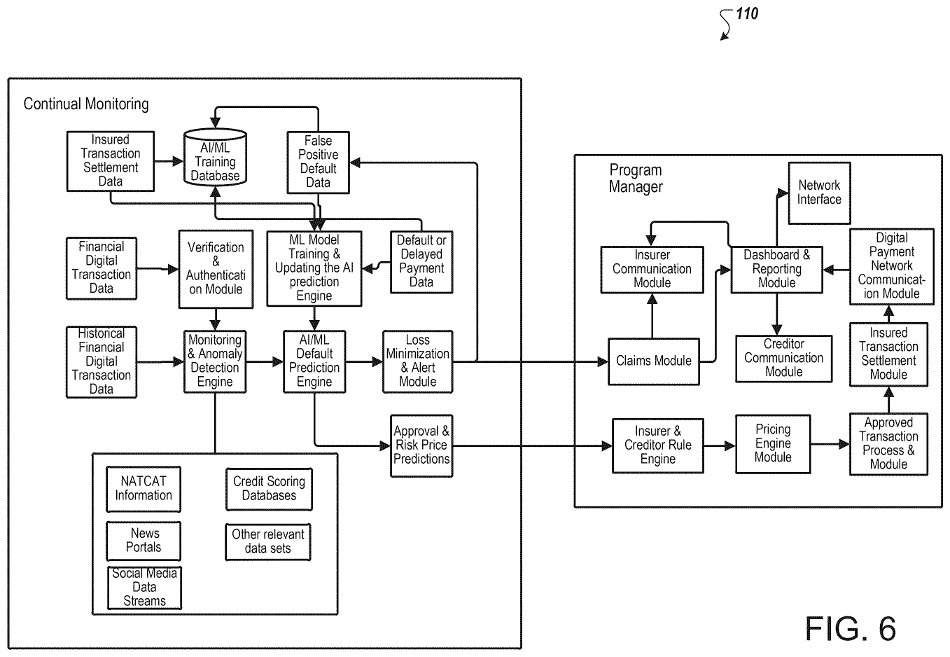

FIG. 6 is a diagram that shows examples of components of a platform that uses machine learning to facilitate interactions among systems over a computer network. The example provides a view of the AI/ML components within the platform the computer system 110 provides, including examples of processes and data flows involved in continual monitoring, risk assessment, and decision-making for transactions.

The computer system 110 can use various data sources, such as: financial digital transaction data providing real-time transaction data; historical financial digital transaction data that includes past transaction data; default or delayed payment data, which provides information describing defaults and delays; and external data, which can include various external data sources like financial news, national catastrophe (natcat) information, supply chain news, social media, etc.

The computer system 110 can include various engines and modules, such as:
a continual monitoring and anomaly detection engine, which monitors transactions and detects anomalies in real-time, including through processing using the machine learning models 116 and based on the information in the profiles 114;
an AI/ML default prediction engine, which can predict the likelihood of potential defaults using AI/ML algorithms, including the machine learning models 116;
a machine learning model training module and AI prediction updating engine, which can repeatedly update and train the models 116 with new data, as well as update other processes (such as the accuracy results for the models 116 and the processes for selecting which models 116 to use for specific transactions); and
a loss minimization and alert module, which detects anomalies or increases in risks and acts to minimize losses and set alerts to stakeholders about potential risks or changes to risk levels over time.

the computer system 110 can include modules for data processing and decision-making, such as:
an approval and risk price prediction module that determines approval and pricing based on risk assessments;
a AI/ML training database that stores data used for training AI/ML models, such as the models 116;
a verification and authentication module that verifies and authenticates transaction data; and
an insurer and creditor rule engine that applies rules for transaction approvals based on insurer and creditor policies.

The computer system 110 can include modules for communication and reporting, such as:
a creditor communication module that facilitates communication with creditors;
a insurer communication module that facilitates communication with insurers;
a digital payment network communication module that interfaces with digital payment networks; and
a dashboards and reporting module that provides reporting and dashboards for monitoring transaction statuses and AI/ML performance.

The computer system 110 can include modules for claims and settlement, such as:
a claims module that manages claims in the event of defaults; and
an insured transaction settlement module that handles the settlement of insured transactions.

The platform's AI/ML components are central to the continuous monitoring and risk assessment of financial transactions. By integrating various data sources and utilizing advanced AI/ML algorithms, the platform can provide real-time decision-making, risk mitigation, and seamless communication among many stakeholders, thereby enhancing the security and efficiency of digital transactions.

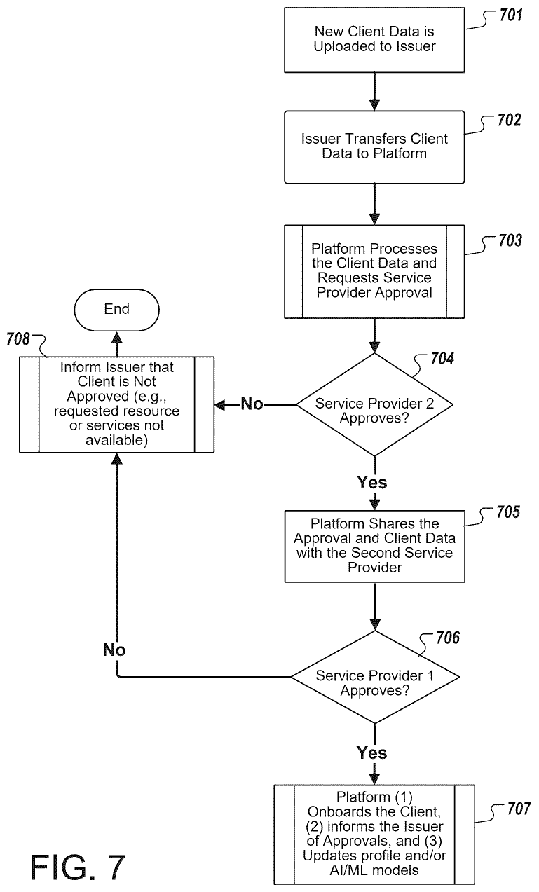

FIG. 7 is a flow diagram that shows an example of operations for initiating interactions with a new entity. This process can be an example of an onboarding process for entities (such as travel intermediaries) to the platform. This process involves multiple steps to ensure that entities meet the necessary criteria for accessing resources and services, such as bundled credit and insurance.

The new entity (e.g., a travel intermediary) provides historical transaction data, credit data, balance sheet data, and know-your-customer (KYC) & anti-money laundering (AML) data to the Issuer Platform (701). The issuer platform transfers the initial onboarding data to the computer system 110 (702). The computer system 110 then processes the received data and shares it with a service provider, e.g., an insurance company, for onboarding approval (703). This can include providing a machine learning prediction based on the output of multiple machine learning models 116. The prediction can be for an overall risk level or expected set of outcomes across a variety of transaction sizes and types. As another example, the prediction can be an indication whether the information represents an anomaly or deviates from patterns known for reliable performance. The service provider, e.g., the insurance company, reviews the data and decides on approval (704). If approved, the computer system 110 shares the insurance approval and data with another service provider, e.g., a credit provider (705). The credit line provider reviews the data and decides on approval (706).

During the interaction, the new entity's historical data is uploaded to the Issuer Platform, which then transfers this data to the computer system 110 for processing and review. For the insurance approval assessment (703), the computer system 110 processes the entity's data and sends it to the insurance company for approval. The insurance company evaluates the data to ensure the entity meets the necessary criteria. For the credit line provider approval assessment (705), upon receiving insurance approval, the computer system 110 shares the information with the credit line provider, who then reviews and decides whether to approve the entity. For onboarding (707), if both the insurance company and credit line provider approve, the computer system 110 officially onboards the entity to be able to receive resources or services. The issuer is informed, and a profile 114 for the entity is created. The machine learning models 116 can also be trained or updated further based on the data for the entity. In some implementations, one or more separate machine learning models can be created and trained for each specific entity (e.g., each travel intermediary, or each entity that requests to receive bundled credit and insurance), and this training of one or more entity-specific machine learning models is performed for the new entity to facilitate future transactions involving the entity. For the rejection notification (708), if either the insurance company or the credit line provider disapproves, the issuer is notified that the new entity is blocked or denied access to the bundled services, e.g., credit and insurance.

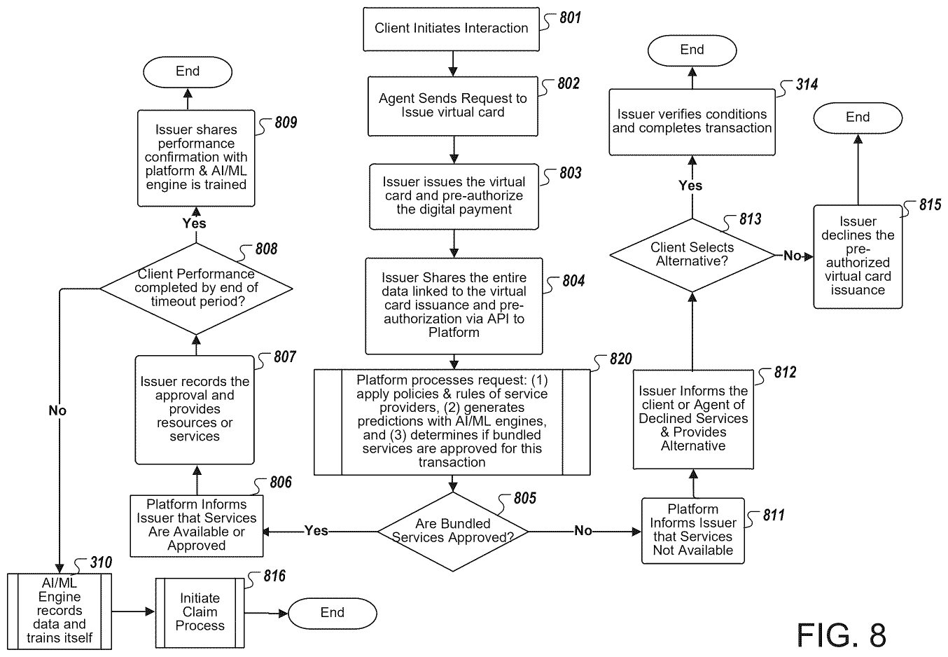

FIG. 8 is a flow diagram that shows an example of operations to monitor for and update machine learning models based on results following machine learning predictions. The example illustrates continual monitoring and risk assessment. Which involves multiple steps to ensure that each digital payment transaction is assessed, financed, and insured appropriately.

The end client initiates a booking and payment process to reserve travel services (801). The travel intermediary selects a due date for the bundled offer and submits a virtual card (e.g., VCN) issuance request to the issuer system (802). The issuer creates records for issuing the virtual card and begins pre-authorizing the digital payment, although actual completion of the transaction is subject to further approval and confirmation. The issuer system provides the computer system 110 the entire data set related to the virtual card issuance and pre-authorization via an API (804). The computer system 110 processes the information according to the policies and rules of the various service providers, and uses AI/ML engines (e.g., including the models 116) to decide if the financing and insurance bundle is approved for the transaction.

In further detail, for booking & payment (801-802), the client books services and initiates payment through the travel intermediary, who selects the due date and submits the virtual card issuance request. Virtual card issuance (803-804) then occurs, in which the issuer issues the virtual card, pre-authorizes the payment, and shares the data with the computer system 110. The next operations include Risk Assessment and Approval (805-807), where the computer system 110 processes the data and determines if the bundled offer is approved. If approved, the platform informs the Issuer, which then releases the credit for the transaction. Following approval, transaction settlement (808-809) proceeds. If the insured and financed transaction is settled at the agreed due date, the issuer shares the settlement confirmation with the computer system 110, and the AI/ML engine (including the models 116) is trained with the outcome data.

If approval is not permitted, then the computer system 110 declines to offer the bundle of services (811-812). If the bundled services are not approved, the issuer informs the client and asks them to provide financing through another channel (e.g., a wire transfer) to proceed without the bundled solution. If the client proceeds without the bundled solution and provides a wire transfer or has sufficient balance, the pre-authorization is processed (813-814). Otherwise, the issuer declines the virtual card issuance (815).

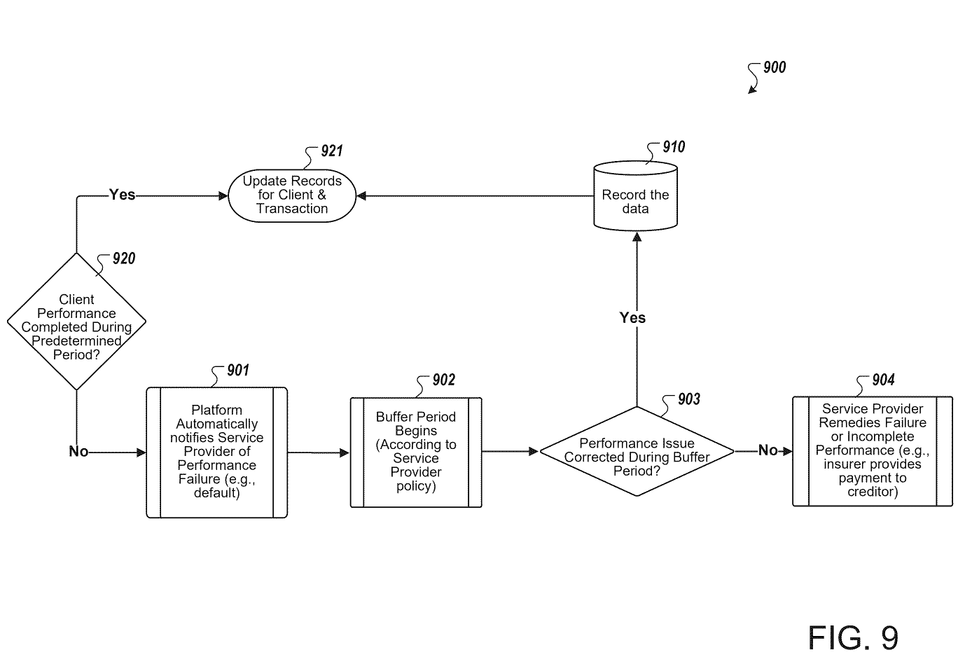

FIG. 9 is a flow diagram that shows an example of operations to detect and mitigate performance issues. For example, the example shows a claims process facilitated by the AI/ML platform in the event of a default on a virtual card number (VCN) payment. The steps involved can ensure that the insurer compensates for the unpaid amount.

After transaction settlement, the computer system 110 determines whether the total VCN amount is settled with the issuer by the due date of the credit period (920). If the amount is settled, the account of the buyer (e.g., a travel intermediary) is cleared to show that no further payment is due. The machine learning models 116 can be updated based on the outcome to improve accuracy for similar situations in the future (921).

If the amount for the VCN is not settled, the computer system 110 automatically flags a potential claim to the insurer (901). A buffer period starts as agreed upon by the insurer (902). The computer system 110 notifies the VCN issuer, and the travel intermediary is reminded through various communication channels (e.g., email, SMS, call, account managers, etc.) about the duty to pay.

In the Initial Settlement Check (920-921), the computer system 110 checks if the total VCN amount is settled by the due date. If settled, the transaction is cleared, and no further action is required. If the amount is not settled, the computer system 110 flags the issue and starts the claims process by notifying the insurer (901). During the buffer period (902), the computer system 110 notifies the VCN issuer and the travel intermediary about the outstanding payment, providing a grace period to settle the amount. The computer system 110 then performs a Buffer Period Settlement Check (403), where the computer system 110 checks if the amount is settled during the buffer period. If settled, the process ends, and the data is recorded. However, If the amount is not settled during the buffer period, the insurer compensates the credit provider for the loss within the agreed timeframe (904). All relevant data is recorded to ensure transparency and for future reference, including for updating profiles 114 for the buyer (e.g., travel intermediary) and updating the machine learning models 116.

A number of implementations have been described. Nevertheless, it will be understood that various modifications may be made without departing from the spirit and scope of the disclosure. For example, various forms of the flows shown above may be used, with steps re-ordered, added, or removed.

Embodiments of the invention and all of the functional operations described in this specification can be implemented in digital electronic circuitry, or in computer software, firmware, or hardware, including the structures disclosed in this specification and their structural equivalents, or in combinations of one or more of them.

Embodiments of the invention can be implemented as one or more computer program products, e.g., one or more modules of computer program instructions encoded on a computer readable medium for execution by, or to control the operation of, data processing apparatus. The computer readable medium can be a machine-readable storage device, a machine-readable storage substrate, a memory device, a composition of matter effecting a machine-readable propagated signal, or a combination of one or more of them. The term “data processing apparatus” encompasses all apparatus, devices, and machines for processing data, including by way of example a programmable processor, a computer, or multiple processors or computers. The apparatus can include, in addition to hardware, code that creates an execution environment for the computer program in question, e.g., code that constitutes processor firmware, a protocol stack, a database management system, an operating system, or a combination of one or more of them. A propagated signal is an artificially generated signal, e.g., a machine-generated electrical, optical, or electromagnetic signal that is generated to encode information for transmission to suitable receiver apparatus.

A computer program (also known as a program, software, software application, script, or code) can be written in any form of programming language, including compiled or interpreted languages, and it can be deployed in any form, including as a stand-alone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processors of any kind of digital computer. Generally, a processor will receive instructions and data from a read only memory or a random access memory or both.

The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices.

Moreover, a computer can be embedded in another device, e.g., a tablet computer, a mobile telephone, a personal digital assistant (PDA), a mobile audio player, a Global Positioning System (GPS) receiver, to name just a few. Computer readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

To provide for interaction with a user, embodiments of the invention can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

Embodiments of the invention can be implemented in a computing system that includes a back end component, e.g., as a data server, or that includes a middleware component, e.g., an application server, or that includes a front end component, e.g., a client computer having a graphical user interface or a Web browser through which a user can interact with an implementation of the invention, or any combination of one or more such back end, middleware, or front end components. The components of the system can be interconnected by any form or medium of digital data communication, e.g., a communication network. Examples of communication networks include a local area network (“LAN”) and a wide area network (“WAN”), e.g., the Internet.

The computing system can include clients and servers. A client and server are generally remote from each other and typically interact through a communication network. The relationship of client and server arises by virtue of computer programs running on the respective computers and having a client-server relationship to each other.

While this specification contains many specifics, these should not be construed as limitations on the scope of the invention or of what may be claimed, but rather as descriptions of features specific to particular embodiments of the invention. Certain features that are described in this specification in the context of separate embodiments can also be implemented in combination in a single embodiment. Conversely, various features that are described in the context of a single embodiment can also be implemented in multiple embodiments separately or in any suitable subcombination.

Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

In each instance where an HTML file is mentioned, other file types or formats may be substituted. For instance, an HTML file may be replaced by an XML, JSON, plain text, or other types of files. Moreover, where a table or hash table is mentioned, other data structures (such as spreadsheets, relational databases, or structured files) may be used.

Particular embodiments of the invention have been described. Other embodiments are within the scope of the following claims. For example, the steps recited in the claims can be performed in a different order and still achieve desirable results.

What is claimed is:

1. A method performed by one or more computers, the method comprising:
receiving, by the one or more computers, a request from a remote system over a communication network, wherein the request identifies a particular entity and indicates characteristics of a requested or proposed interaction involving the particular entity;
accessing, by the one or more computers, a profile for the particular entity, wherein the profile comprises profile data that indicates patterns or characteristics of activity of the particular entity that were determined from records of previous interactions of the entity or of other entities;
generating, by the one or more computers, an output from each of multiple machine learning models that have each been trained to predict a likelihood of an outcome, wherein each output indicates a likelihood of the outcome for the requested or proposed interaction, and wherein each output is generated by the corresponding machine learning model based on input indicating (i) characteristics of the requested or proposed interaction and (ii) information from the profile for the particular entity;
generating, by the one or more computers, a prediction for the outcome based on the outputs of the machine learning models; and
based on the prediction generated based on the outputs of the machine learning models, selectively reserving, by the one or more computers, a resource or service from one or more service provider systems over the communication network and providing a response to the remote system.

2. The method of claim 1, wherein the machine learning models comprise at least one of a neural network, a reinforcement learning model, a support vector machine, a classifier, a regression model, a clustering model, a decision tree, an anomaly detection model, a random forest model, a genetic algorithm, a Bayesian model, or a Gaussian mixture model.

3. The method of claim 1, further comprising determining that the prediction satisfies one or more predetermined criteria for providing the resource or service for the requested or proposed interaction;
wherein selectively reserving the resource or service from the one or more service provider systems comprises:
in response to determining that the prediction satisfies the one or more predetermined criteria, communicating with the one or more service provider systems over the communication network to cause the resource or service to be provided for the requested or proposed interaction.

4. The method of claim 3, wherein communicating with the one or more service provider systems comprises providing, over the communication network, (i) information from the request indicating the characteristics of the requested or proposed interaction, and (ii) an indication of the prediction or an indication that the prediction satisfies the one or more predetermined criteria.

5. The method of claim 1, further comprising determining that the prediction does not satisfy one or more predetermined criteria for providing the resource or service for the requested or proposed interaction;
wherein selectively reserving the resource or service from the one or more service provider systems comprises:
in response to determining that the prediction does not satisfy the one or more predetermined criteria, (i) not reserving the resource or service for the requested or proposed interaction, and (ii) sending a message to the remote system indicating that the resource or service is not provided for the requested or proposed interaction.

6. The method of claim 1, wherein selectively reserving, by the one or more computers, the resource or service from one or more service provider systems comprises coordinating with each of multiple service providers such that the multiple service providers respectively provide different resources or services to complete the requested or proposed interaction.

7. The method of claim 6, wherein a first resource or service provided by at least one of the multiple service providers is provided conditionally based on availability of a second resource or service from another of the multiple service providers; and
wherein coordinating with each of multiple service providers comprises obtaining confirmation of availability of the second resource or service to enable the first resource or service to be provided.

8. The method of claim 1, wherein selectively reserving, by the one or more computers, the resource or service from one or more service provider systems comprises:
coordinating with a first service provider system to provide a first type of resource or service and a second service provider system to provide a second type of resource or service, wherein the second type of resource or service is different from the first type of resource or service, and wherein providing the second type resource or service of second is conditioned on providing the first type of resource or service, wherein the coordinating comprises:
providing, to the first service provider system, prediction data indicating the prediction for the outcome for the proposed or requested interaction or an indication that the prediction satisfies one or more predetermined criteria;
after providing the prediction data, receiving, from the first service provider system, a first confirmation message indicating that the first type of resource or service is allocated for the requested or proposed interaction;
providing, to the second service provider system, an indication that the first service is allocated for the proposed or requested interaction; and
after providing the indication to the second service provider system, receiving, from the second service provider system, a confirmation that the second type of resource service is reserved or allocated for the requested or proposed interaction.

9. The method of claim 1, wherein the output from each of the machine learning models comprises at least one of a probability score, a classification result, a detected anomaly, or a confidence score.

10. The method of claim 1, wherein generating the prediction for the outcome based on the outputs of the machine learning models comprises:
generating the prediction based on an ensemble of the machine learning models, including determining an amount or proportion of the outputs that indicate that a likelihood of the outcome exceeds a predetermined threshold or represents an anomaly.

11. The method of claim 1, wherein generating the prediction for the outcome based on the outputs of the machine learning models comprises generating a combined score based on the outputs of the multiple machine learning models.

12. The method of claim 11, wherein generating the combined score comprises determining a weighted combination in which different outputs have different levels of contribution or influence to the combined score based on previous performance of the machine learning models.

13. The method of claim 1, wherein the output from each of the machine learning models comprises an importance score for each of multiple different factors, wherein the importance scores in the output of a machine learning model indicate relative levels of contribution of the corresponding factors to a prediction output of the machine learning model.

14. The method of claim 1, wherein each of the machine learning models is configured to receive input indicating a value for each of multiple different features; and
wherein generating the output from each of the machine learning models comprises generating, for each of the multiple machine learning models, (i) a prediction output indicating a likelihood of the outcome or a likelihood of an anomaly in the outcome and (iii) an importance score for each of the multiple different features, wherein each importance score indicates a level of influence or impact of the corresponding feature on the prediction output of the machine learning model.

15. The method of claim 1, further comprising:
receiving multiple requests for different types of interactions or for different entities; and
using a dynamic ensemble of models to generate predictions for the multiple requests, including, for each of the multiple requests, using a different subset of machine learning models based on one or more of the entity involved, the type of interaction, characteristics of the interaction, or content of a profile of an entity involved in the interaction or one or more associated entities.

16. The method of claim 1, further comprising:
storing a plurality of machine learning models that have each been trained to predict a likelihood of the outcome; and
selecting a subset of the machine learning models in the plurality of machine learning models for the requested or proposed interaction;
wherein the generating the output from each of the multiple machine learning models comprises generating an output from each of the machine learning models in the subset of the machine learning models.

17. The method of claim 16, further comprising determining performance measures indicating accuracy of the outputs of the different machine learning models in the plurality of machine learning models in different contexts;
wherein selecting the subset of the machine learning models comprises selecting, from the plurality of machine learning models, a subset of the machine learning models that the performance measures indicate to have the highest performance in a context corresponding to the requested or proposed interaction.

18. The method of claim 16, further comprising:
accessing a selection model that has been trained to predict or score the relevance of different machine learning models for different contexts; and
generating, for each of the machine learning models in the plurality of machine learning models, an output of the selection model indicating a relevance of the machine learning model to a context corresponding to the requested or proposed interaction;
wherein selecting the subset of the machine learning models in the plurality of machine learning models for the requested or proposed interaction comprises selecting the subset based on the outputs of the selection model.

19. A system comprising:
one or more computers; and
one or more computer-readable media storing instructions that are operable, when executed by the one or more computers, to cause the one or more computers to perform operations comprising:
receiving, by the one or more computers, a request from a remote system over a communication network, wherein the request identifies a particular entity and indicates characteristics of a requested or proposed interaction involving the particular entity;
accessing, by the one or more computers, a profile for the particular entity, wherein the profile comprises profile data that indicates patterns or characteristics of activity of the particular entity that were determined from records of previous interactions of the entity or of other entities;
generating, by the one or more computers, an output from each of multiple machine learning models that have each been trained to predict a likelihood of an outcome, wherein each output indicates a likelihood of the outcome for the requested or proposed interaction, and wherein each output is generated by the corresponding machine learning model based on input indicating (i) characteristics of the requested or proposed interaction and (ii) information from the profile for the particular entity;
generating, by the one or more computers, a prediction for the outcome based on the outputs of the machine learning models; and
based on the prediction generated based on the outputs of the machine learning models, selectively reserving, by the one or more computers, a resource or service from one or more service provider systems over the communication network and providing a response to the remote system.

20. One or more computer-readable media storing instructions that are operable, when executed by one or more computers, to cause the one or more computers perform the operations comprising:
receiving, by the one or more computers, a request from a remote system over a communication network, wherein the request identifies a particular entity and indicates characteristics of a requested or proposed interaction involving the particular entity;
accessing, by the one or more computers, a profile for the particular entity, wherein the profile comprises profile data that indicates patterns or characteristics of activity of the particular entity that were determined from records of previous interactions of the entity or of other entities;
generating, by the one or more computers, an output from each of multiple machine learning models that have each been trained to predict a likelihood of an outcome, wherein each output indicates a likelihood of the outcome for the requested or proposed interaction, and wherein each output is generated by the corresponding machine learning model based on input indicating (i) characteristics of the requested or proposed interaction and (ii) information from the profile for the particular entity;
generating, by the one or more computers, a prediction for the outcome based on the outputs of the machine learning models; and
based on the prediction generated based on the outputs of the machine learning models, selectively reserving, by the one or more computers, a resource or service from one or more service provider systems over the communication network and providing a response to the remote system.
